(19) United States
(12) Patent Application Publication
(10) Pub. No.: US 2011/0010195 A1
(43) Pub. Date: Jan. 13, 2011

(54) MEDICAL HISTORY SYSTEM

(76) Inventor: Steven Charles Cohn, Cortlandt Manor, NY (US)

Correspondence Address: HOFFMANN & BARON, LLP, 6900 JERICHO TURNPIKE, SYOSSET, NY, 11791, US

(21) Appl. No.: 12/499,468

(22) Filed: Jul. 8, 2009

(51) Int. Cl. G06Q 50/00; G06F 17/30; G06Q 10/00

(52) U.S. Cl. 705/3; 707/E17.044; 707/E17.045

(57) ABSTRACT

Embodiments described herein include generating a navigable medical history corresponding to a patient. Reference information related to medical records for the patient is stored in a referenced records database based on a standardized healthcare code in the medical records. The reference information is inserted into the referenced records database by the medical history system. The medical history system generates the navigable medical history associated with the patient based on the reference information.

### BACKGROUND

1. Technical Field

The presently disclosed embodiments are directed to generating and maintaining a navigable medical history associated with a patient.

2. Brief Discussion of Related Art

When a patient visits a healthcare provider a medical record memorializing the visit is generated. The medical records can be generated or transformed into an electronic medical record that is stored in a medical records database. The medical record can include information regarding tests, procedures, symptoms, diagnoses, and the like, as well as codes, typically a standardized healthcare code. In some cases, the standardized healthcare code can be used to bill insurance providers for the services of the healthcare provider.

The medical record database is typically specific to the healthcare facility at which the healthcare provider performed the services. As such, patient medical records associated with different facilities can be stored in separate, disparate, and independent medical records databases. Healthcare providers, such as doctors, who are not affiliated with a given healthcare facility and/or who have not received authorization from the patient in compliance with the Health Insurance Portability and Accountability Act (HIPAA) may not have access the medical records database associated with the given facility. As a result, the healthcare provider may not have an accurate and complete medical history for his/her patient.

Medical records can typically be retrieved from a medical records database using a query protocol specified by the medical records database, where each of the disparate independent medical records databases can specify a different database structure and query protocol. Typically, to retrieve independent and separate medical records from a medical records database, the user enters key terms into a search query and the medical records database returns medical records matching the key terms. However, the independent and separate medical records returned in response to the search query may include medical records for a group of patients having medical records matching the key terms. This approach, however, typically does not provide the user with an overall view of a patient's medical history and can be insufficient for identifying chronic, episodic, and/or on-going medical conditions. In addition, this approach may not return medical records that may be relevant to the retrieved medical records, but that do not match the key terms in the search query.

Further, since separate, disparate, independent medical records databases can have different querying protocols, a user who has access to the medical records databases must know and understand the querying protocols before the user can efficient retrieve medical records. For example, the user typically must know how to structure a query and what key terms to use for the query. Performing independent searches on each of the medical records databases results in an inefficient and burdensome process for the user and does not provide an integrated and efficient approach to patient care and management.

### SUMMARY

Embodiments disclosed herein include a method, medium, and system for generating and maintaining a navigable medical history for one or more patients. Reference information related to medical records for a patient can be stored in a referenced records database based on an association between a healthcare code in the medical records and medical discipline categories defined by a medical history system. The reference information is inserted into the referenced records database by the medical history system.

The medical history system generates a navigable medical history associated with the patient based on the reference information. The navigable medical history is organized by the medical discipline categories to facilitate a review of disciplines. A list including a content subcategory can be displayed in response to a selection of a first one of the medical discipline categories. The content subcategory can include a description of content contained in one or more of the medical records. The list can include an entry identifying a number of medical records that correspond to the content subcategory, an entry identifying a first date on which the patient was serviced, and a last date on which the patient was serviced corresponding to the medical records referenced by the content subcategory. The navigable medical history can include a last record accessed list identifying a status of at least one of the medical records for which the reference information is stored.

Embodiments disclosed herein can also include displaying reference information associated with the one or more of the medical records in response to a selection of the content subcategory, inserting a link into the reference information, and retrieving a corresponding one of the medical records from a medical records database in which the corresponding one of the medical records resides in response to a selection of the link. The corresponding one of medical records is stored and maintained independently from the medical history system.

Embodiments disclosed herein can also include generating a predefined relationship between the content subcategory and a second one of the medical discipline categories, determining when a user selects the content subcategory associated with the first one of the medical discipline categories, and alerting the user of the relationship between the content subcategory and the second one of the medical discipline categories in response to a selection the content subcategory.

Embodiments disclosed herein can also include determining identities of healthcare providers who have treated the patient using the reference information and generating a list of the healthcare providers who have treated the patient. The list includes a total number of medical records each of the healthcare providers have generated for the patient and includes a time span over which each of the healthcare providers have treated the patient.

Embodiments disclosed herein can also include receiving search terms for identifying the patient, displaying a list of potential patients matching the search terms, and retrieving the navigable medical history in response to a selection of the patient from the list of potential patients.

Embodiments disclosed herein can also include retrieving medical records associated with the patient from independent disparate medical records databases and copying the reference information from the medical records that are retrieved.

The presently disclosed embodiments advantageously generate an efficient, integrated, and accurate medical history of a patient to facilitate performance of a review of systems, review of disciplines, review of continuous care records, review of health maintenance records, or other type of review (hereinafter collectively referred to as a “review of disciplines”). In some embodiments, the review of disciplines can be performed without requiring the user to retrieve and analyze independent medical records. Users of the presently disclosed embodiments can, for example, determine whether a patient has an isolated, chronic, on-going, and/or serious medical condition based on the information contained in the navigable medical history. Additionally, the presently disclosed embodiments provide an easy to use interface that allows a user without medical knowledge, such as a patient, to use and understand the patient's medical history.

The above and other aspects of the present invention will become apparent upon consideration of the following detailed description of preferred embodiments thereof, particularly when taken in conjunction with the accompanying drawings wherein like reference numerals in the various figures are utilized to designate like components.

### BRIEF DESCRIPTION OF THE DRAWINGS

FIG. 1 depicts a block diagram of an exemplary medical history system.

FIG. 2 depicts an exemplary computing device for implementing embodiments of a medical history coordinator.

FIG. 3 depicts an exemplary computer system for implementing embodiments of the medical history system.

FIGS. 4-23 illustrate an exemplary navigable medical history associated with a patient.

FIG. 24 is a flowchart for implementing an exemplary process of generating and maintaining a navigable medical history

FIG. 25 is a flowchart for implementing an exemplary navigation of the navigable medical history.

### DETAILED DESCRIPTION

Exemplary embodiments include a medical history system for generating, maintaining a navigable medical history associated with one or more patients to facilitate a performance of a review of disciplines. As used herein, a “medical history” refers to information obtained from medical records of a patient, but that does not include the actual medical records and a “navigable medical history” refers to a medical history that can be browsed by a user to view a patient's medical history. The medical history system can be accessible by users twenty-four (24) hours a day, seven (7) days a week and facilitates efficient discovery of medical records that are associated with a patient and provides an integrated medical history that references medical records stored in independent disparate medical records databases.

The medical history system promotes a comprehensive exchange of information and an efficient approach to patient care and management. Embodiments of the medical history system provide a unifying approach to review of a patient's medical history using an ultimate navigation tool that generates integrated views of a patient's medical history based on medical records that may be distributed and isolated among disparate independent medical records databases. Changes to standards, guidelines, and the underlying reference information used to generate the navigable medical history are reflected in the review of disciplines facilitated by medical history system in real-time so that users of the medical history system can instantaneously access up-to-date information provided by the medical history system. As a result, changes are reflected instantaneously in clinical pathways over which healthcare providers receive information, formularies for medications and vendors specific to insurance companies. Any future changes in medical reference libraries, educational references, clinical pathways, care guidelines (e.g., Milliman Care Guidelines), formularies, vendors, management protocols, etc., are reflected equally and instantaneously to all UMR records.

Using the medical history system allows a patient's “chief complaint” to be translated into healthcare codes, which are integrated into a review of disciplines, treatment plans, referrals, lab orders, prescriptions, home healthcare referrals, consults, results, and outcomes, which further automate medical records. For example, a patient can be automatically called or alerted to make sure various tests and procedures are performed prior to visiting a healthcare professional.

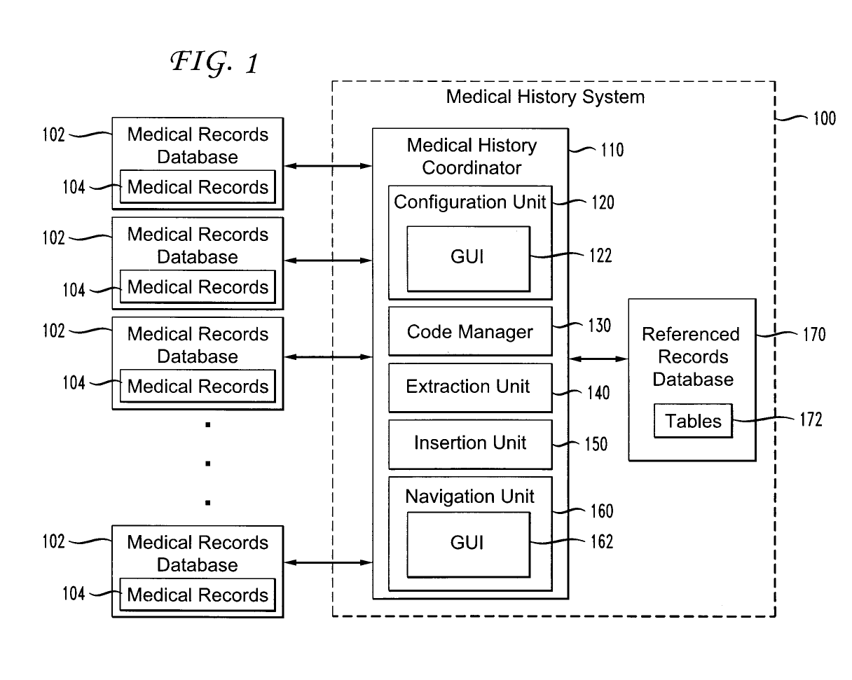

FIG. 1 depicts a block diagram of a medical history system 100 (hereinafter “system 100”) for facilitating access to a patient's complete medical history in an integrated and efficient manner. The system 100 interfaces with medical records databases 102 to discover or otherwise identify medical records 104 associated with a patient and to copy reference information from the medical records 104 to generate the patient's medical history. Reference information can include, for example, a healthcare code, patient ID, patient name, provider ID, provider name, healthcare facility ID, healthcare facility name, date on which the medical services were provided, diagnostic information, medical testing information, medical procedure information, SOAP notes (i.e., subjective, objective, assessment, and plan notes), and the like. The system 100 can require HIPPA compliance such that some, all, or none of the users must have appropriate authorization under HIPPA to access the system 100. The system 100 includes a medical history coordinator 110 (hereinafter “coordinator 110”) and a referenced records database 170.

The medical records databases 102 can be independent disparate medical records databases maintained by individual healthcare facilities or institutions (hereinafter “healthcare facilities”), such as hospitals, pharmacies, home care, nursing homes, assisted living facilities, laboratories, out-patient facilities, in-patient facilities, rehabilitation facilities, doctors' offices, insurance companies, medical records companies, and the like, for storing electronic medical records 104 (hereinafter “medical records 104”). For example, some, all, or none of the medical records databases 102 can be formed as a part of a Regional Health Information Organization (RHIO), in which participating members can access medical records from each of the medical records databases formed under the RHIO. Individuals who are not members of the RHIO and/or who do not have authorization from the patient in compliance with HIPAA generally do not have access to the medical records databases formed under the RHIO. Although, the medical records databases 102 are illustrated as being separate from the medical history system 100 in the present example, those skilled in the art will recognize that one or more of the medical records databases 102 can be integrated with the medical history system 100.

Medical records can be stored in different formats and can include different information. Embodiments of the medical history system can be configured to accommodate some or all medical record formats so that the system provides a flexible and inclusive architecture to facility efficient and complete review of disciplines. Some, all, or none of the medical records 104 are created in accordance with specifications generated by the Health Level Seven (HL7) and American Society for Testing and Materials (ASTM) organizations. For example, the medical records can be created using the Clinical Document Architecture (CDA) specifications set forth by HL7, the Continuity of Care Record (CCR) set forth by the ASTM, or the Continuity of Care Document (CCD) set forth in collaboration by HL7 and ASTM. In some embodiments, the medical records can include clinical data, such as lab results, test results, procedure results, diagnostic studies, laboratory studies, consult letters, electrocardiograms (ECGs), pulmonary function tests (PFTs), referrals, and so on. In some embodiments, universal guidelines, such as Healthcare Effectiveness Data and Information Set (HEDIS) criteria, for disease management systems are integrated into some, all, or none of the medical records. The costly and time-delaying manual prior approval process is automated by the use of each vendor's prerequisite codes housed in the review of disciplines. The medical records are preferably generated independent of the system 100 such that the system 100 preferably does not provide a mechanism for generating medical records. The system 100 interfaces with generated medical records to generate a navigable medical history based on information in the generated medical records.

The system 100 allows users, such as healthcare providers including doctors, nurses, nurse practitioners, physician assistants, psychologists, social workers, medical staff, pharmacists, insurance providers, emergency medical technicians (EMT), emergency medical service (EMS) personnel, paramedics, caregivers, and the like, as well as patients themselves to view an integrated navigable medical history for the patients. The medical history references one or more of the medical records 104 that are stored in the disparate medical records databases 102, each of which can have their own database structure and querying protocol. The system 100 presents users with information about a patient's medical history that may not be apparent upon independent review of the patient's medical records.

Retrieval of the medical records from the disparate medical records databases 102 is performed without requiring the user to perform text-based searches or queries on the disparate medical records databases 102 and does not require a user to know or understand querying languages, query terms, query protocol, or healthcare codes. Thus, users of the system 100 can retrieve and understand medical records in an efficient manner without requiring medical training. For example, the system 100 can allow the patients themselves to view and understand their medical history.

The coordinator 110 includes a configuration unit 120, a code manager 130, an extraction unit 140, an insertion unit 150, and a navigation unit 160. The components of the coordinator 110 can be implemented using one or more software procedures. Software procedures are software segments that can be implemented to perform functions and/or operations for storing, retrieving, maintaining, displaying, and the like, data, which is used to form a navigable medical history. For example, the software procedures can store, retrieve, modify (e.g., add, delete, change), maintain, display, and the like, information in the tables stored in the referenced records database.

The configuration unit 120 includes a graphical user interface (GUI) 122 and allows an administrative user to configure user information. For example, the configuration unit 120 allows an administrative user to add or delete users having access to the medical history coordinator 110 using the GUI 122. An administrative user is a user who has permission to control access to the system 100. The configuration unit 120 can allow an administrative user to edit user information, such as a user name, password, user identification (ID), phone number, electronic mail (e-mail) address, industry affiliation (e.g., healthcare, insurance, patient), a visibility used to determine the extent to which patients medical history can be viewed by a user, group used to identify which patients' medical histories a user can view, and the like, using the GUI 122 by entering the information in data entry fields. Once a user has been added, the user can access the coordinator 110 by logging in using, for example, the user ID and password.

The code manager 130 generates and maintains mappings between standardized healthcare codes, medical discipline categories, and content subcategories. Standardized healthcare codes can include Current Procedural Terminology (CPT) codes, Healthcare Common Procedure Coding System (HCPS), International Statistical Classifications of Diseases (ICD) codes, National Drug Codes (NDCs), Minimum Data Set (MDS) codes, and the like. Medical discipline categories can include, for example, allergy of medication, anesthesiology, cardiovascular medicine, childhood disease history, dental medicine, dermatology, emergency medicine, endocrinology, gastroenterology, general medicine, genetics, genitourinary medicine, hematology and oncology, immunization history, immunology and allergy, infectious disease, medical procedure, neonatology, nephrology, neurology, obstetrics and gynecology, opthalmology, orthopedics, otorhinolaryngology, pathology and laboratory, pediatrics, prescription and medication, prosthetic device, psychiatry, pulmonology, radiology, rehabilitation medicine, rheumatology, social history, surgical procedure, and the like.

The mapping identifies one or more medical discipline categories and content subcategories under which a medical record having a particular healthcare code should be referenced. The mapping can be performed using tables, extensible mark-up language (XML) based documents, and the like. When a new medical record is discovered in one of the disparate medical records databases 102, reference information related to the medical record is inserted under one or more of the medical discipline categories and content subcategories in a navigable medical history using the mapping so that the user of the system 100 can view the reference information related to the newly discovered medical record and can ultimately retrieve the actual medical record from the disparate medical records database in which the actual medical record resides. For example, the user can retrieve a medical record related to an electrocardiogram (ECG) and/or can retrieve the ECG results upon selecting a link in the navigable medical history.

The code manager 130 maintains code versions so that when the standardized healthcare codes are modified or updated, the code manager 130 archives the previous version of the standardized healthcare code and includes the new version of the standardized healthcare code in a listing of healthcare codes. The new version of the healthcare code is mapped to the previous version of the healthcare code as well as to the one or more medical discipline categories and/or content subcategories to which the previous version of the standardized healthcare code was mapped. In this manner, the medical history coordinator 110 maintains an up-to-date record of standardized medical codes and seamlessly transitions between the versions to ensure reference information related to a patient's medical records are catalogued properly in the system 100. The comprehensive repository of the medical codes allows specificity coding by the proper combinations of codes to be included into more specific codes which describe the appropriate increased complexity of the disease processes. This can be integrated from, for example, individual contributions from previous healthcare histories, lab data, and lab results.

The system 100 can provide a triage function that presents relevant information to users in a concise, integrated, and cohesive structure for clinical management of disease processes and review of disciplines. The review of disciplines is integrated into the system based on the geneology (i.e., information root) of healthcare codes associated with the referenced information. The medical discipline categories can be generated and partitioned based on a geneology of the healthcare codes. For example, the healthcare codes are broken down to their geneology so that the fundamental relationship and meaning of the healthcare codes dictates which medical discipline categories are used and which medical discipline categories are associated with which healthcare codes. By breaking the healthcare codes down into their geneology, the healthcare codes are manifested in the navigable medical history for review of disciplines through the medical discipline categories; thereby forming an efficient, easily understood structure by which user can perform the review of disciplines.

Using this approach, a healthcare code, and other referenced information associated with the healthcare code, can be integrated into one or more medical discipline categories based on the relationship of the geneology of the healthcare code to the medical discipline categories. Integrating the healthcare codes, and other referenced information associated with the healthcare codes, into the system 100 based on the geneology of the healthcare codes ensures that an evaluation of a primary medical discipline category automatically presents other secondary medical disciplines categories specifically related to the healthcare codes found in the primary medical discipline category. Thus, an evaluation of a primary medical discipline category is broadened by the geneology to include important sharing of data of the healthcare codes to include secondary medical discipline categories to facilitate identification of additional reference information that can be mutually shared, or otherwise contained, by other medical specialties discipline categories.

The extraction unit 140 interfaces with the independent disparate medical records databases 102 and is configured to access the disparate medical records databases 102 based on a query protocol and/or database structure supported by the disparate medical records databases 102. The extraction unit 140 retrieves medical records from the disparate medical records databases 102 for patients whose medical history is maintained by the system 100 as the records become available to facilitate an up-to-date medical history for the patients in real-time. The extraction unit 140 copies the standardized healthcare codes from the medical records as well as other information already in the medical records, such as a code type, a code version, a date of service, a patient ID, patient name, health facility name, health facility ID, provider name, provider ID, diagnosis information, test results, SOAP notes, and the like. The extraction unit 140 can poll the disparate medical databases 102 periodically to detect whether new medical records have been added to the disparate medical databases 102. For example, the extraction unit 140 can check the disparate medical databases 102 weekly, daily, hourly, about every minute, about every second, and so on. In some embodiments, the disparate medical databases 102 can communicate with the system 100 to identify new medical records that have been added and the extraction unit 140 can copy the standardized healthcare codes and other information from the new medical records as needed.

Using the standardized healthcare codes copied from the medical records by the extraction unit 140, the insertion unit 150 inserts reference information related to the medical records into the referenced records database 170. The insertion unit 150 inserts the reference information into the tiered structure of the referenced records database 170 under one or more of the medical discipline categories and content subcategories corresponding to the standardized healthcare codes copied from the medical records. The insertion unit 150 also detects whether references to medical records have a standardized healthcare code that already exists in the referenced records database 170. If so, the insertion unit 150 increments a frequency indicator associated with the reference information corresponding to medical records having the same standardized healthcare code. Additionally, the insertion unit 150 can determine a time period that identifies an amount of time between the first known date of service and the last known date of service. This allows users of the system to determine whether a medical condition of a patient is isolated, chronic, episodic, on-going, and the like, and in some instances the severity of the medical conditions without requiring a full analysis of the actual independent medical records.

In some embodiments, the system 100 can interface with a Computer Patient/Physician Order Entry (CPOE) application. CPOE applications allow healthcare providers to enter, for example, instructions for the treatment of patients. These entries provide a medical record documenting the healthcare provider's instructions. As one example, the extraction unit 140 can interface with the CPOE application to automatically extract reference information in real-time from the CPOE entries and the insertion unit 150 can insert the reference information into the referenced records database allowing reference information pertaining to the order entries to be immediately available to users of the system 100. Interfacing CPOE applications with the system 100 allows reference information, such as, for example, plans for new prescriptions, changes to the plans, diagnostic studies, referrals, and so on, to be captured and integrated into the navigable medical history in real-time to promote a review of disciplines using up-to-date reference information that includes CPOE entries. Each new order can immediately reference the existing database of the same codes and display them for comparative reference information before deciding if the new order of this same code is appropriately necessary.

The navigation unit 160 includes a graphical user interface (GUI) 162 that allows users to navigate through referenced medical records of a patient in the referenced records database 170 based on the medical discipline categories and content subcategories to which the references have been assigned. The GUI 162 presents a top level view that includes a list of medical discipline categories from which the user can choose as well as a table of contents. When a user selects a medical discipline category, the GUI 162 displays a list of content subcategories associated with the medical discipline category selected by the user. The content subcategories provide a brief description of medical diagnoses, procedures, or test, referred to in the medical records that are referenced under the content subcategories. Upon selection of one of the content subcategories, a list of referenced medical record entries associated with the patient having a healthcare code that has been mapped to the medical discipline category and content subcategory is displayed. Links can be provided for each referenced medical record entry in the list to allow the user to retrieve the actual medical record from one of the independent disparate medical records databases 102 where the medical record actually resides.

After selecting a category and content subcategory, the navigation unit 160 alerts the user of further medical discipline categories that should be reviewed. For example, the navigation unit 160 can alert the user to medical discipline categories that include reference information related to additional medical records, which may be related to, or provide some insight to, a medical condition referenced in the list of medical records being viewed, but that does not include the same healthcare codes and that is not be associated with the same medical discipline category in the database. This ensures that the user receives complete and accurate medical history for a patient. For example, medical discipline categories that are cross linked with the referenced medical record can be displayed, highlighted, flashing, different colors from the remaining categories, and the like.

The navigation unit 160 can provide export buttons that are selectable by a user during browsing the navigable medical history of a patient. The export buttons allow a user to export the navigable medical history or a portion of the navigable medical history. Some examples of export buttons include a fax button for faxing the navigable medical history or portion of the navigable medical history, e-mail button for e-mailing the navigable medical history or portion of the navigable medical history, a print button for printing the navigable medical history or portion of the navigable medical history, a voice dictate button for outputting speech using a text-to-speech algorithm to dictate navigable history or portion of the navigable medical history, a send to mobile button to send the navigable medical history or portion of the navigable medical history to a smart phone, a print e-prescribe button that prints a prescription, a send to healthcare provider button to send reference information to a specific healthcare provider, and the like.

The navigation unit 160 can also track or otherwise maintain a reviewer record of a review of disciplines performed by a healthcare provider to provide documentation that the healthcare provider performed a review of disciplines. By tracking or maintaining a record the system allows a healthcare provider to bill for the review of disciplines performed by the healthcare provider. As one example, the navigation unit 160 can track the selections and/or pages viewed in the navigable medical history and can determine that the healthcare provider satisfied the requirements to allow the healthcare provider to bill for the review of disciplines. Additionally, the system promotes fraud/abuse detection by maintaining an integrated medical history of patients. As a result of this integrated, comprehensive approach, problems inherent in the healthcare system will be readily discernable. For example, because the system 100 tracks usage and outcome (e.g., diagnoses, test results, lab results, and so on), this information can be used to prevent inappropriate replication of services, which can result in redundant/multiple billing by a healthcare provider.

The referenced records database 170 stores references to medical records stored in the disparate medical records databases 102. The referenced records database 170 has a tiered structure maintained by the medical records coordinator 110 that is based on medical discipline categories and content subcategories, which are mapped to standardized healthcare codes by the code manager 130. References to medical records of patients are inserted into the tiered structure of the referenced records database 170 by the insertion unit 150 based on healthcare codes copied from the medical records by the extraction unit 140. A single medical record can be referenced under multiple medical discipline categories.

The referenced records database 170 can include tables 172 for organizing reference information, user information, patient information, healthcare provider information, healthcare facility information, healthcare code information, mappings, and the like. Information in the tables can be retrieved using procedures and/or primary keys (PKs). Primary keys are identifiers that when specified uniquely identify sets of entries in a table corresponding the primary keys.

Some examples of tables that can be included in the referenced records database 170 can include a code modifier table; healthcare provider information table; a patient information table (linked to healthcare provider table); a patient diagnosis table; a healthcare provider-to-institution table; one or more tables storing standardized healthcare codes, code types, and version information; and one or more category level tables. Those skilled in the art will recognize that other tables can be implemented for organizing and storing information used to generate, maintain, and facilitate navigation of a navigable medical history. Further, those skilled in the art will recognize that the referenced records database can be implemented using other formats and that tables illustrate an exemplary approach for implementing the referenced records database 170.

The code modifier table includes a modifier code, a code version, and code descriptions. The code modifiers supplement standardized healthcare codes to indicate that a diagnoses, procedures, or tests have been altered due to one or more circumstances, but have not been changed in its definition or code. The code modifiers can indicate a service or procedure includes a professional and/or a technical component, a service or procedure was provided more than once, a service or procedure has been increased or reduced, only part of a service was performed, unusual events occurred, a bilateral procedure was performed, and so on. One or more code modifiers can be associated with a standardized healthcare code in a medical record. This information can be copied to the referenced records database 170 for use in the navigable medical history.

The healthcare provider information table includes healthcare providers associated with patients whose medical histories are accessible using the system 100. The table can include entries for a healthcare provider's last name, first name, phone number, fax number, institution ID, area of practice (e.g., Neurology), address, website address, e-mail address, and the like. Information concerning a specific healthcare provider can be retrieved from the table by the coordinator 110 using a provider ID, which is a primary key that is used to uniquely identify a particular healthcare provider.

The healthcare facility table includes healthcare facilities associated with patients whose medical histories are accessible using the system 100. The healthcare facility table can include entries for a healthcare facility name, facility type (e.g., Hospital), phone number, fax number, address, website, e-mail address, and the like. Information concerning a specific healthcare facility can be retrieved from the table by the coordinator 110 using a healthcare facility ID, which is a primary key that is used to uniquely identify a particular healthcare facility.

The healthcare provider-to-healthcare facility table includes a mapping between healthcare providers and healthcare facilities. The table associates healthcare providers with healthcare facility at which the healthcare provider provides care. The healthcare provider can be associated with one or more healthcare facilities and the table can include mappings between the healthcare provider and each of the healthcare facilities. For example, the healthcare provider may be facilitated with a private practice and may also be associated with a hospital at which the healthcare provider performs surgery and/or procedures. The healthcare provider-to-institution table can include provider IDs, healthcare facility IDs, and institution-healthcare provider ID, which represents the mapping between healthcare providers and healthcare facilities.

The patient information table includes information for patients whose medical histories are accessible using the system 100. The patient information table includes entries for a patient name, address, insurance plan, date of birth, gender, occupation, blood type, languages spoken, last medical exam date, healthcare provider ID corresponding to a healthcare provider associated with the patient (e.g., a primary care doctor), a last updated entry corresponding to a last date and/or time the patient's medical history has been updated, a user group entry corresponding to which users can access the patient's medical history, and the like. The patient information table is linked to the healthcare provider table to map healthcare providers to one or more patients so that when a patient's medical history is being navigated, the user can view the healthcare providers that have treated the patient. Information concerning a specific patient can be retrieved from the patient information table by the coordinator 110 using a patient ID and a patient ID modifier, which are primary keys that are used to uniquely identify a particular patient.

The healthcare codes tables include information for the standardized healthcare codes. The information can include a code type (e.g., CPT, ICD, HCPS, MDS, NDC), a standardized healthcare code, a code version, whether the code applies to males, females, or both males and females, other details concerning the standardized healthcare codes, and the like. In some embodiments, code types can be separated into a separate healthcare codes table or each code type can be included in a single table. In other embodiments, some code types can be included in a single healthcare codes table and other code types can be included in one or more other healthcare codes tables. For example, in one embodiment, the CPT, ICD, HCPS, and MDS codes can be integrated into a single table and the NDC codes can be included in a separate table

The level tables can include first level table, a second level table, and a third level table for arranging the tiered structure of the navigable medical history. The first level table can include medical discipline categories identifiers, which correspond to medical discipline categories recognized by the system 100. The first level represents the first, root, or top level of the tiered structure. The second level can include the content subcategories identifiers, which correspond to content subcategories recognized by the system 100. The second level table represents a second level in the tiered structure. The third level table can include record identifiers, which correspond to healthcare code descriptions recognized by the system 100. The identifiers included in the level tables can be strings of characters which reference, or point to, locations at which the actual medical discipline categories, content subcategories, and healthcare codes can be retrieved.

The actual medical discipline categories, content subcategories, and healthcare code descriptions can be stored in one or more dictionary tables. The dictionary tables provide a centralized location of medical discipline names, content subcategory names, healthcare code descriptions, and the like. Using this approach allows for efficient updating of medical discipline content names, content subcategories, and healthcare code descriptions. The one or more dictionary tables are used by the coordinator 110 in conjunction with other tables, such as the level tables, healthcare codes tables, patient information table, healthcare provider information table, healthcare facility table, and so on, to generate a navigable medical history for a patient. For example, when the user requests the medical history of a patient, the coordinator 110 can access the level tables to retrieve the identifiers and subsequently access the dictionary tables to retrieve the medical discipline categories, content subcategories, and healthcare code descriptions using the identifiers.

The patient diagnoses table includes diagnosis information for patients and is mapped to the healthcare codes tables. The patient diagnosis table includes entries for whether the patient was hospitalized, a healthcare facility ID, a provider ID, a modifier code, version, and a visibility (e.g., which users can view the patient's diagnosis information). Information concerning a diagnosis of a specific patient can be retrieved from the patient diagnosis table by the coordinator 110 using a patient ID, patient ID modifier, code type, code version, and healthcare code, which are primary key that are used to uniquely identify a particular patient's diagnosis information in the patient diagnoses table.

The system 100, and more specifically, the coordinator 110 can maintain, track, and archive reference information associated with a patient throughout a patient's lifetime and beyond to provide a complete history of the patient to promote accurate medical diagnoses based on past experiences, symptoms, test results, procedures, diagnoses, environmental factors, and so on. Additionally, the system 100 can provide a comprehensive medical information bureau from the birth to the death of a patient independent and regardless of the patient's insurance carrier or lack thereof. The system 100 provides accurate information from all perspectives insuring that the insurance companies can have access to a patient's medical history to provide enhanced managed care on behalf of the patient and providing the healthcare providers with integrated health information to promote better guidelines for the patient.

The system 100 promotes disease management at the patient level, the local level, the regional level, the national level, and the global level by coordinating a review of disciplines using the navigable medical history. Users of the system can identify trends, patterns, diagnosis rates, and so on, to facilitate tracking and understanding of the epidemiology of illnesses. User can perform outcome analysis at an individual, local, regional, national, and/or global level to allow for comparative studies to be performed and trends to be identified, and pandemics can be followed in real-time. The users can also use the system 100 to generate predictive models both for individual patients and group of patients (e.g., family member, classmates, nursing home residents, and so on). Predictive modeling using the system 1000 can facilitate planning of medical portion of the Gross National Product (GNP).

The system 100 enables inventory control and fraud/abuse monitoring. For example, the system 100 can track inventory supplies, such as needles, bed pans, medications, and so on, by incorporating this information into the reference information stored in the referenced records database 170. As inventory is depleted, it can be reflected in the system 100 so that users can determine when to reorder items and can determine how many items are being used within a given period.

The system 100 can allow for cost analysis based on the comprehensive medical histories maintained by the system 100. For example, each disease management process can be evaluated using the reference information to identify costs. Using this information, the users of the system 100 can predict budget requirements.

The system 100 facilitates communication to HIPPA compliant parties. Such communication can include calling, messaging, paging, texting, faxes, e-mailing, alerts, alarms, and so on, to generate new communication highways for healthcare automation. For example, time sensitive information can be provided to healthcare providers immediately in response to changes in a patient's status. In the nursing home environment, predetermined care plans can be automated using the system 100 to trigger upon activations, notifications, paging, documentation, MDS code changes, and so on, to foster and enhance patient safety and to simplify nursing care. Using these communication channels, the system 100 can also promote patient adherence. As one example, the system 100 can facilitate an evaluation of medication and appointment adherence by, for example, automatically contacting the patient and/or a healthcare provider to provide reminders regarding medication refills and scheduled appointments. In this manner, the system can provide a TICKLER system or can interface with a TICKLER system to schedule communications according to future dates on which action is required by the patient and/or healthcare provider.

The comprehensive medical history generated for patients by the system 100 can be used as a resource and documentation in legal proceedings, medical malpractice issues, employment health records, workmen's compensation issues, and so on. For example, the system 100 can be used during discovery in legal cases to uncover documentation that may be relevant to the legal case, such as, for example, healthcare provider oversight, medication control, negligent care, and so on. Likewise, regarding medical malpractice, the comprehensive medical histories maintained by the system 100 allows for retrospective, real-time, and prospective disease management to minimize frivolous law suits. With respect to employee health records and workmen's compensation issues, the system provides an easy and efficient mechanism for maintaining a medical history in compliance with the Americans with Disabilities Act to facilitate transparent documentation for worker's compensation injuries.

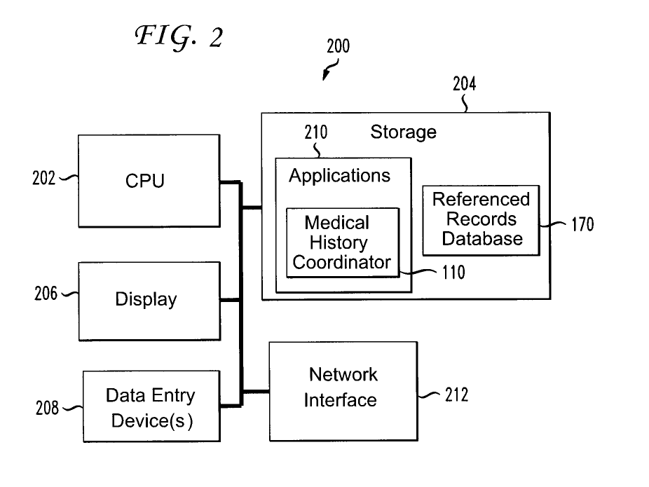

FIG. 2 depicts an exemplary computing device 200 for implementing embodiments of the medical history coordinator 110 of the medical records system 100. The computing device 200 can be a mainframe, personal computer (PC), laptop computer, workstation, handheld device, such as a PDA, or the like. In the illustrated embodiment, the computing device 200 includes a central processing unit (CPU) 202 and storage 204. The storage 204 can include such technologies as a floppy drive, hard drive, compact disc, tape drive, Flash drive, optical drive, read only memory (ROM), random access memory (RAM), and the like. The computing device 200 can further include a display unit 206 and data entry device(s) 208, such as a keyboard, touch screen, microphone, and/or mouse.

Applications 210, such as the medical history coordinator 110, can be resident in the storage 204. The storage 204 can include instructions for implementing the medical history coordinator 110. The instructions can be implemented using, for example, C, C++, Java, JavaScript, Basic, Perl, Python, assembly language, machine code, and the like. The storage 204 can be local or remote to the computing device 200. The computing device 200 includes a network interface 212 for communicating with a communication network. The CPU 202 operates to run the applications 210 in storage 204 by performing instructions therein and storing data resulting from the performed instructions, which may be presented to a user. The data in the storage 204 can include the referenced records database 170, although those skilled in the art will recognize that the referenced records database 170 can be in a different storage component that may be remote to the storage 204.

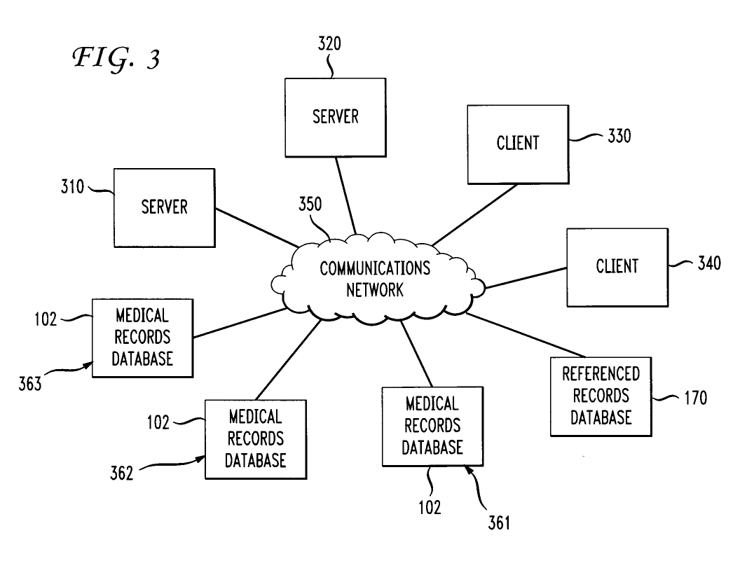

FIG. 3 depicts an exemplary computing system 300 for implementing embodiments of the medical records system 100. The computing network 300 includes one or more servers 310 and 320 coupled to clients 330 and 340, via a communication network 350, which can be any network over which information can be transmitted between devices communicatively coupled to the network including, for example, the Internet, an intranet, a virtual private network (VPN), Wide Area Network (WAN), Local Area network (LAN), and the like. The computing network 300 can also include repositories or database devices 360-363, which can be coupled to the servers 310/320 and/or clients 330/340 via the communications network 350. The database devices 360-363 can be used to implement the medical records databases 102 and the referenced records database 170. The servers 310/320, clients 330/340, and database devices 360-363 can be implemented using a computing device, such as a computing device implemented in a similar manner as the computing device 200 of FIG. 2. Alternatively, or in addition, the client 330 and 340 can be implemented as mobile phones, smart phones, a personal digital assistant (PDA), other handheld wireless devices configured to access the medical history system 100, the implementation of which is known to those skilled in the art. The coordinator 110 can be implemented using a single computing device or can be implemented in a distributed manner using multiple computing devices.

The servers 310/320, clients 330/340, and/or database devices 360-363 can store information, such as components of the system 100, medical records, reference information related to medical records for patients, user information, standardized healthcare codes, medical disciplines categories and content subcategories, and the like. In some embodiments, the medical history system 100 can be distributed among the servers 310/320, clients 330/340, and/or database devices 360-363 such that one or more components of the medical records system 100 and/or a portion of one or more components of the medical records system 100 can be implemented by a different device (e.g. clients, servers, databases) in the communication network 350.

For example, the medical history coordinator 110 can be resident on the server 310 as a web application, the referenced records database 170 can be implemented using the database device 360, and the disparate medical records databases 102 can be implemented using the database devices 361-363. In the present example, users can access the medical records system 100 using a web browser, mobile phone widget, applet, or other client side application implemented on the client devices 330 and 340. The user can navigate to, for example, a Uniform Resource Identifier (URI) address, such as a Uniform Resource Locator (URL) address, at which the user can log on to the system 100.

Communication between the various devices of the distributed system can be implemented using various protocols and technologies. Devices communicating over the communications network 350 can interact using peer-to-peer (P2P) and/or client-server based protocols implementing, for example, web service calls, hypertext transfer protocol (HTTP) requests and posts, and the like.

In some embodiments, the client device 330/340 can be a portable wireless device, such as a smart phone or a personal digital assistant, carried by the user. The user can use the portable wireless device to access the patient's navigable medical history at any time and at any location from which the user has access to the communications network 350. For example, the user can be the patient who is traveling in another country. If the user becomes ill and must seek medical attention while traveling, the user can log in to the medical history system and forward his medical history to a healthcare provider that will provide the medical attention so that the healthcare provider can use the medical history during the visit.

As another example, the user is a healthcare provider who is away from his office when a patient requires assistance. The healthcare provider can receive a message on his portable wireless device identifying the patient in need of assistance and in response can log in to the medical history system to view the patient's medical history. The healthcare provider can respond to the message with instructions for treating or testing the patient and/or can forward the patient's medical history to another healthcare provider that is covering for the healthcare provider in his absence. Those skilled in the art will recognize that other exemplary applications of the medical history system can be implemented and that the embodiments of the medical history system are not limited to the exemplary application disclosed herein.

As another example, the medical history system can respond automatically when a patient calls a healthcare facility by retrieving the patient's navigable medical history for review by one or more healthcare providers. For example, when a patient calls the healthcare facility, the caller ID can identify the patient and this information can be input to the system 100 to search and retrieve the patient's navigable medical history.

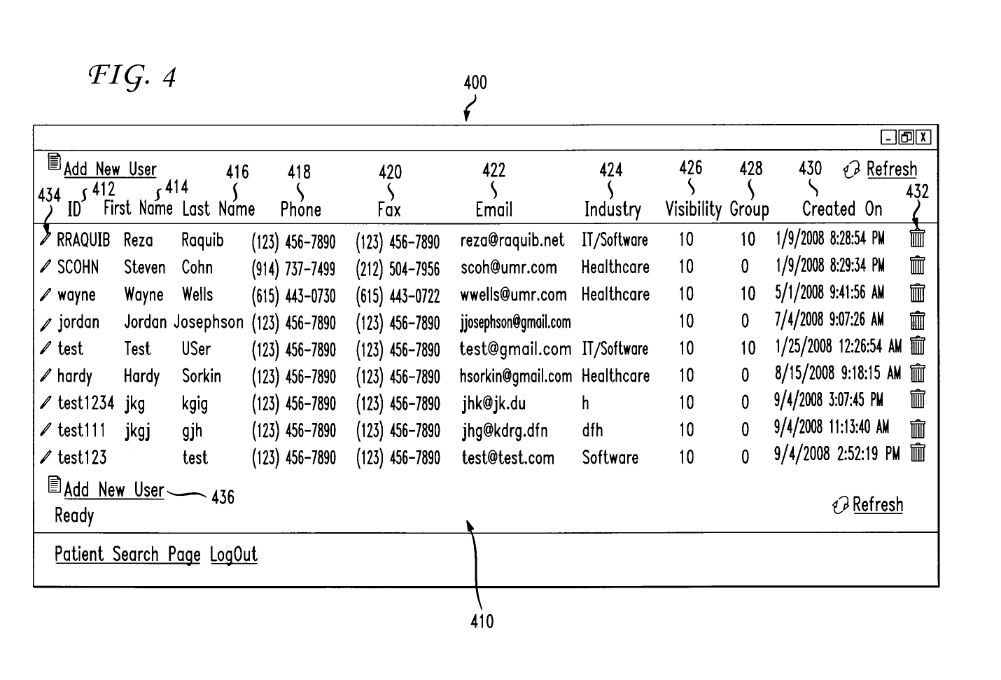

FIGS. 4-23 illustrate an exemplary implementation of a navigable medical history generated by the medical history system 100. In the present embodiment, the navigation unit of the medical history coordinator 110 is implemented as a web application having a graphical user interface. While the medical history coordinator 110 is implemented as a web application, those skilled in the art will recognize that the form in which the medical history coordinator 110 is implemented can vary.

Referring to FIG. 4, after a user has logged in to the medical records system 100, the user can access a user configuration page 400, which includes a table 410 of users that can access the system 100. The table 410 includes user information arranged in columns for user IDs 412, fist names 414, last names 416, telephone numbers 418, fax numbers 420, e-mail addresses 422, industry association 424, visibility 426, group association 428, and when a user profile was created 430. The user can delete a user by selecting a “delete” button 432 and can modify user information by selecting a “modify” button 434. Likewise, a user can add a new user to the table by selecting the “Add New User” button 436, which results in a user details page being displayed to the user.

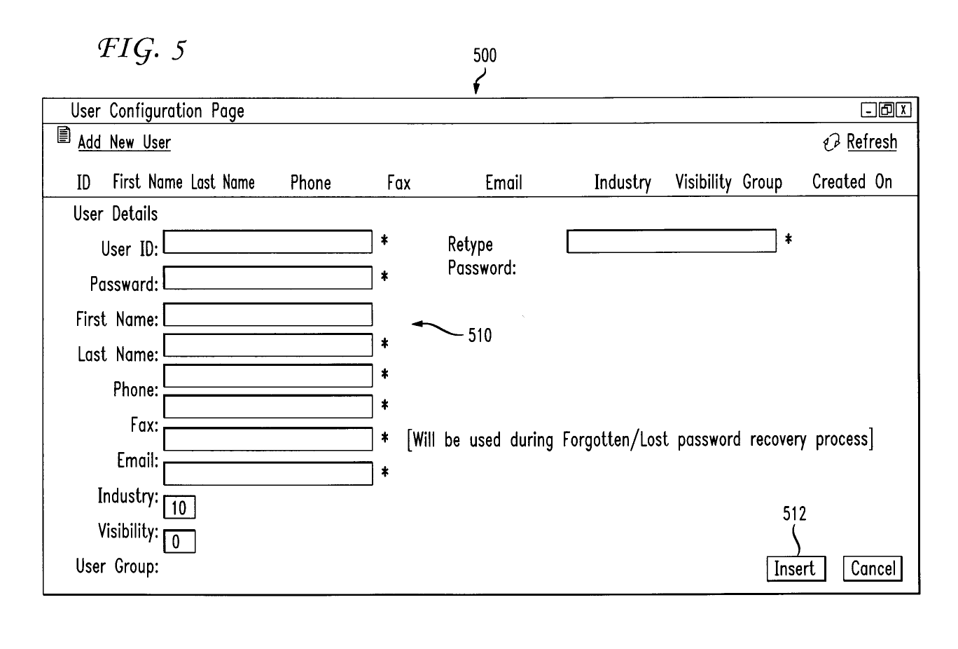

FIG. 5 illustrates an exemplary user details window 500 that can be displayed when a user selects the button 436 in the user configuration page 400 (FIG. 4). The user detail page 500 includes data entry fields 510 for receiving user information relating to the user to be added. Once the requisite information has been added, the user can select the “insert” button 512 to add the new user to the table 400 so that the new user can access the system 100.

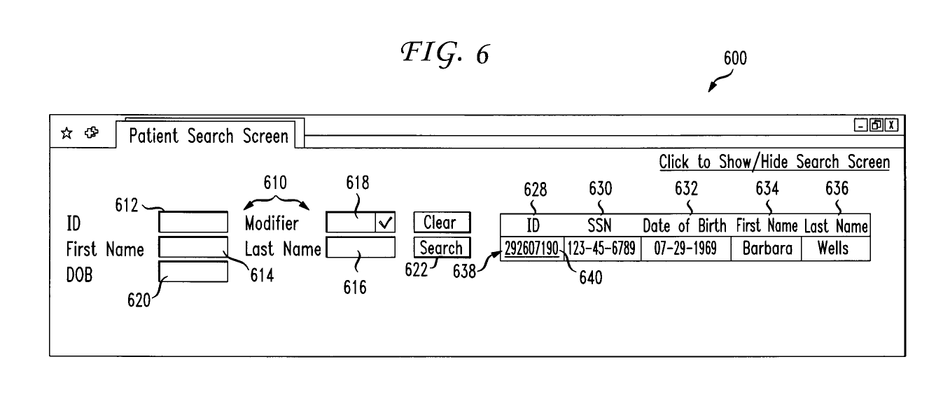

Upon logging into the medical records system 100, the user can navigate to a patient search screen 600, as shown in FIG. 6. The patient search screen 600 can include data entry fields 610 for receiving information regarding a patient for which the user wishes to search. The data entry fields 610 include a patient ID field 612, a patient first name field 614, a patient last name field 616, a modifier field 618, and a date of birth field 620. The user can enter information into one or more of the data entry fields 610 and can select a “search” button 622 to search for patients satisfying the information entered into the date entry fields 624. In some embodiments, patients associated with the user are displayed and patients that are not associated with the user are not displayed. For example, a healthcare provider can access the medical history system 100 and can access the medical history of the healthcare provider's patients, but cannot access another healthcare provider's patients unless authorized.

The patient search results can be displayed to the user in a table 626, which includes columns for a patient ID 628, patient social security number (SSN) 630, date of birth 632, first name 634, and last name 636. The user can select a patient from the table 626 to view the patient's medical history. For example, a patient ID 638 in the table 626 can include a selectable link 640, which upon selection causes a top level navigable medical history screen to be displayed for the patient having the associated patient ID 638.

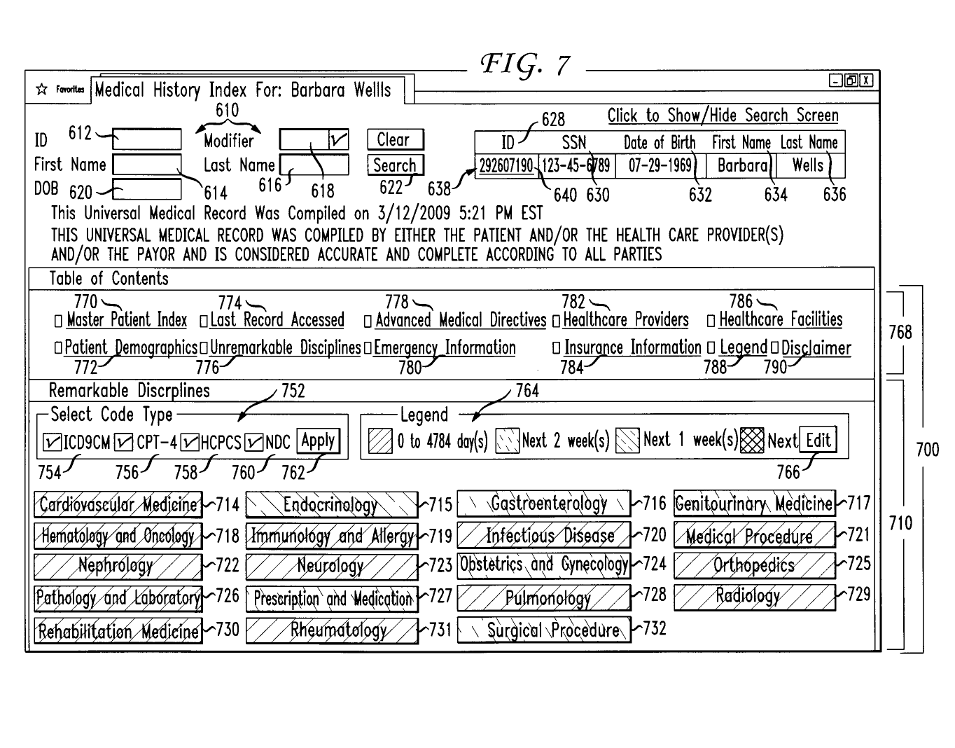

FIG. 7 illustrates an exemplary top level navigable medical history screen 700 that can be displayed to the user in response to a selection of a patient from the patient search results. The top level medical history screen 700 includes a remarkable disciplines section 710 in which a list 712 of selectable medical discipline categories is provided. In some embodiments, the list 712 includes all medical discipline categories regardless of whether there is any reference information associated with the medical discipline categories. In some embodiments, only those medical discipline categories for which reference information exists are included in the list 712. For these embodiments, medical discipline categories can be added to the list 712 as reference information becomes available for the medical discipline categories not included in the list 712. Medical disciplines that are not included in the list 712 can be included in an unremarkable discipline list.

In the present example, the list 712 of selectable medical discipline category buttons includes a “Cardiovascular Medicine” button 714, “Endocrinology” button 716, “Gastroenterology” button 718, “Genitourinary Medicine” button 720, “Hematology and Oncology” button 722, “Immunology and Allergy” button 724, “Infectious Disease” button 726, “Medical Procedure” button 728, “Nephrology” button 730, “Neurology” button 732, “Obstetrics and Gynecology” button 734, “Orthopedics” button 736, “Pathology and Laboratory” button 738, “Prescription and Medication” button 740, “Pulmonology” button 742, “Radiology” button 744, “Rehabilitation Medicine” button 746, “Rheumatology” button 748, and a “Surgical Procedure” button 750. The user can select the medical discipline categories to view content subcategories by activating the buttons (e.g., clicking on the buttons with a mouse) in the list 712 of medical discipline categories. In some embodiments, only medical discipline categories for which medical records exist are included in the list 710 of medical discipline category buttons so that a user knows which medical discipline categories are available in the patient's medical history. In other embodiments, the list 710 of medical category buttons includes all of the medical discipline categories regardless of whether medical references corresponding to the medical discipline categories exist.

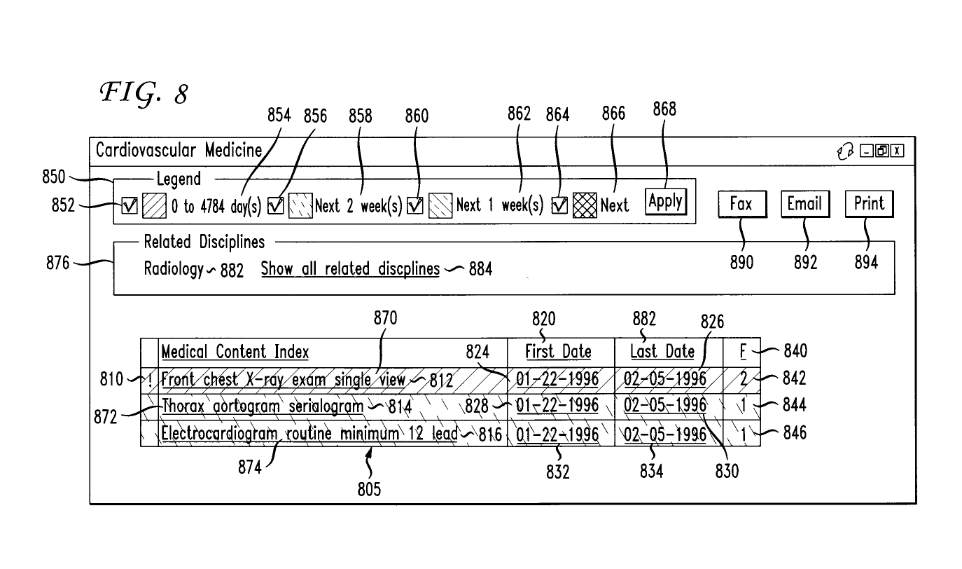

FIG. 8 illustrates an exemplary discipline window 800 that is displayed when the user selects the “Cardiovascular Medicine” button 714. The discipline window 800 includes a list 805 of content subcategories. An identifier 810 can be associated with content subcategories to indicate the healthcare codes have been updated. The content subcategories provide a brief description of the content of medical records, such as diagnoses, procedures, tests, and the like, referenced under the content subcategories. The brief descriptions are predefined based on the standardized healthcare codes in the actual medical records being referenced. In the present example, the list 805 of content subcategories includes a content subcategory 812 described as a “Front chest X-ray exam single view”, a content subcategory 814 described as a “Thorax aortogram serialogram”, and a content subcategory 816 described as an “Electrocardiogram routine minimum 12 lead”. Each content subcategory is associated with a unique standardized healthcare code.

The list 805 can include a first date of service 820 (hereinafter “first date 820”) and a last date of service 822 (hereinafter “last date 822”) for each of the content subcategories in the list 805. The first and last dates can be extracted from the reference information maintained by the medical history system 100. The first date 820 indicates the first time a medical record was created for a corresponding medical discipline category and content subcategory and the last date 822 indicates the last time a medical record was created for a corresponding medical discipline category and content subcategory. For example, the content subcategory 812 includes a first date 824 and a last date 826, the content subcategory 814 includes a first date 828 and a last date 830, and the content subcategory 816 includes a first date 832 and a last date 834. Using the first and last dates 820 and 822, a user can determine a time span over which medical records of the patient for a particular standardized healthcare code were created. In some embodiments, the medical history system 100 can calculate the time span and include it in the list 805. The time span can indicate to the user that the patient is suffering from an isolated, chronic, episodic, on-going illness, and/or being monitored for a condition.

The list 805 also includes a frequency 840 of medical records referenced under a corresponding medical discipline category and content subcategory. For example, the content subcategory 812 includes a frequency 842, the content subcategory 814 includes a frequency 844, and the content subcategory 816 includes a frequency 846. In the present example, the frequency 842 is two, the frequency 844 is one, and the frequency 846 is one. This indicates that two medical records are referenced under the medical discipline category “Cardiovascular Medicine” and the content subcategory “Front chest X-ray exam single view”, one medical record is referenced under the medical discipline category “Cardiovascular Medicine” and the content subcategory “Thorax aortogram serialogram”, and that one medical record is referenced under the medical discipline category “Electrocardiogram routine minimum 12 lead”. The frequency 840 of medical records referenced under a corresponding medical discipline category and content subcategory indicate the severity of a condition, how closely the condition was monitored, recurring conditions, and the like.

The discipline window 800 can include a content subcategory filtering section 850 (hereinafter “filtering section 850) to allow the user to include and/or exclude some, all, or none of the content subcategories in the list 805 based on when medical referenced under the content subcategories were last changed (e.g., when the medical records were last created, updated, modified, etc). The filtering section 850 includes a selectable check box 852 corresponding to a first time period 854, a selectable check box 856 corresponding to a second period of time 858, a selectable check box 860 corresponding to a third period of time 862, and a selectable check box 864 corresponding to a fourth period of time 866.

The user can include content subcategories in the list 805 corresponding to one or more of the time periods 854, 858, 862, and 866 by checking the check boxes corresponding to the those time periods and can exclude content subcategories from the list 805 by unchecking the check boxes corresponding to the those time periods. To apply the filter, the user can select the “Apply” button 868, which excludes content subcategories that do not include a reference to a medical record that has been created, updated, or modified within one or more time periods corresponding to checked check boxes. The content subcategories in the list 805 can be color coded to correspond to the time periods 854, 858, 862, and 866 so that the user readily discern from the list when medical records referenced under the content subcategories last changed.

The content subcategories in the list 805 can include selectable links that allows the user to view a list of related medical discipline categories and/or to navigate to a diagnosis details page associated with a selected content subcategory. In the present embodiment, the content subcategory 812 includes a link 870, the content subcategory 814 includes a link 872, and the content subcategory 816 includes a link 874. The links 870, 872, and 874 can be implemented so that when a user clicks on the links a single time, a related disciplines section 876 displays a list of medical discipline categories which can include references to medical records that are related to the referenced medical records in the selected content subcategory and when the user double clicks on the link a diagnosis details page associated with a selected content subcategory is displayed.

For example, still referring to FIG. 8, the user can select the content subcategory 814 by clicking the link 872 a single time and the medical history system can display a list 880 including related medical discipline categories, such as the medical discipline category “Radiology”, which can include a link for navigating to the content subcategories of the “Radiology” medical discipline category. Alternatively, the user can select a “Show all related disciplines” link 884, upon which the medical history system displays the related disciplines side-by-side so that the user can readily compare and review the content subcategories listed in the related medical discipline categories.

In some embodiments, the discipline window 800 can include export buttons for exporting a patient's naviagable medical history or a portion of the patient's navigable medical history. Some examples of export buttons include a fax button 890, an e-mail button 892, and a print button 894, which when activated open windows to facilitate faxing, e-mailing, and printing, respectively, the patient's medical history, a portion of the patient's medical history, selected sections of the patient's medical history, a current screen, page, or window, and the like. For example, the user can choose to fax or e-mail a portion of the navigable medical history currently being viewed by the user to, for example, a healthcare provider that the patient is scheduled to visit, the patient's insurance provider, first responders, or others who have been identified by the user. The user can enter the fax number(s) to which the medical history should be faxed or can enter the e-mail addresses to which the medical history should be e-mailed. One skilled in the art will recognize that the fax, e-mail, and print buttons are exemplary illustrations of an export button and that other export buttons can be implemented. For example, other export buttons can include a voice dictate button that when activated converts text-to-speech to dictate reference information, a send to mobile button to send reference information to a smart phone, a send to healthcare provider to send reference information to a specific healthcare provider, and the like. Furthermore, while the export buttons are illustrated on some of the navigation pages, those skilled in the art will recognize that the export buttons can be implemented on all, some, or none of the navigation pages.

When the user is the patient, the medical history system allows the patient to control the distribution of his/her medical history. For example, the user can login to the medical history system using a client device, such as a smart phone and can forward the medical history to a healthcare provider who the patient is scheduled to visit. As another example, the patient can forward the patient's medical history to first responders, for example, emergency medical service (EMS) personnel in route to the patient's location or the EMS personnel can already have access to the patient's navigable medical history such that the EMS personnel can review the patient's medical history while in route to the patient's location.

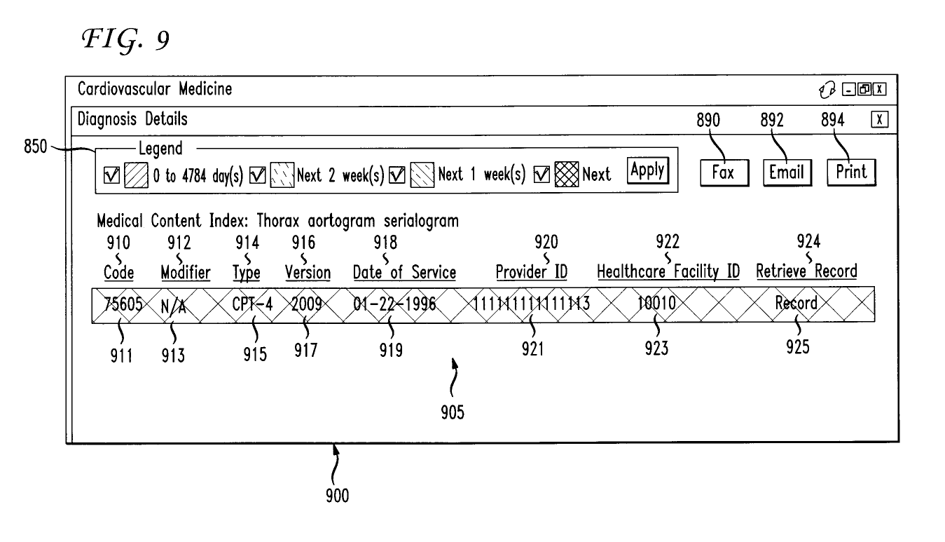

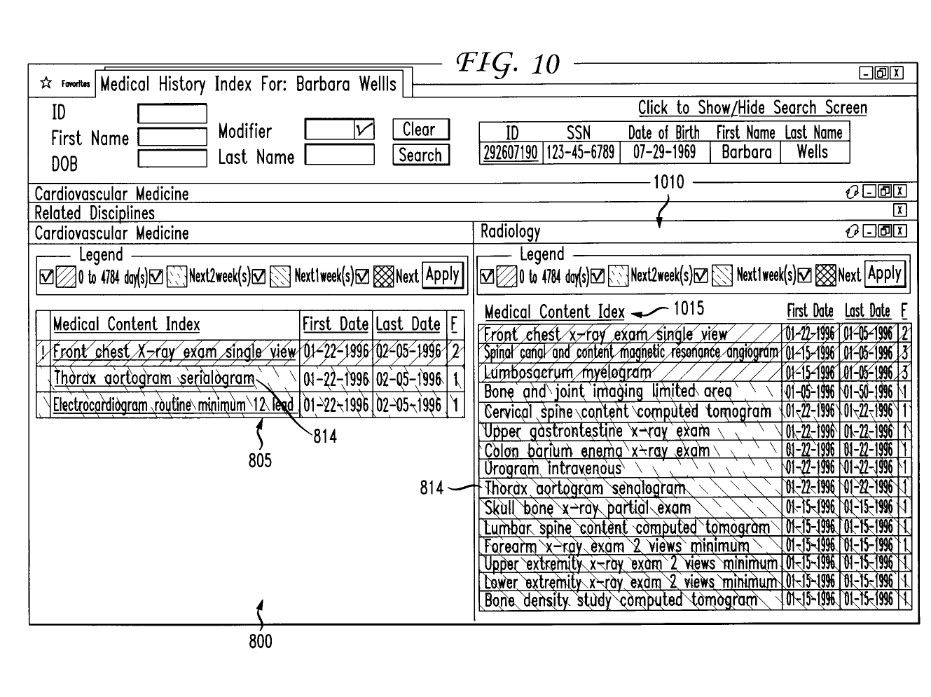

FIG. 9 is an exemplary diagnosis page 900 that can be displayed when the user selects (e.g., by double clicking) the content subcategory 814 (FIG. 8). The navigation unit 160 can implement, for example, one or more software procedures to retrieve data from one or more of the tables including, for example, the patient diagnosis table, to be displayed in the diagnosis page 900. The diagnosis page 900 can include the filtering section 850, fax button 890, e-mail button 892, and print button 894. The diagnosis page 900 includes a list 905 of referenced medical records the medical history system has catalogued under the medical discipline category “Cardiovascular Medicine” and the content subcategory “Thorax aortogram serialogram”. The list can include a code field 910, a modifier field 912, a type field 914, a version field 916, a date of service field 918, a provider ID field 920, a healthcare facility ID field 922, and a retrieve record field 924. The code field 910 includes the standardized healthcare code 911 associated with the medical record being referenced in the list 905. The modifier field 912 include a code modifier 913 associated with the standardized healthcare code 911 and copied from the medical record being referenced in the list 905. The type field 914 identifies a type 915 of healthcare code used in the code field 910 and the version field 916 identifies a version 917 (e.g., revision year) of the code used in the code field 910. Some examples of types of standardized healthcare codes include CPT codes, ICD codes, HCPS codes, NDCs, MDS codes, and the like. The date of service field 918 identifies a date 919 when services referenced by medical record were provided to the patient.

The provider ID field 920 includes a unique identifier 921 associated with a healthcare provider, such as a doctor, who created the referenced medical record and the healthcare facility ID field 922 includes a unique identifier 923 associated with a healthcare facility at which the provider provided care for the patient. The unique identifiers 921 and 923 can be links that when selected result in provider information and healthcare facility information, respectively. The provider information can include the name, phone number, fax number, healthcare facility affiliation, area of practice or specialty, and the like. The healthcare facility information can include healthcare facility name, facility type (e.g., inpatient, outpatient, assisted living, nursing home, etc.), phone number, fax number, address, and the like.

The retrieve record field 924 can include links, for example, link 925 to the referenced medical record in the list 905. Upon selection of the link 925, the medical history system retrieves the medical record for display from one of the independent medical records databases. The medical history system interfaces with the independent medical records database using the protocol and query structure specified by the independent medical records database query the medical records database and retrieve the medical record.

FIG. 10 illustrates an exemplary side-by-side display 1000 of related medical discipline categories including the discipline window 800 for the “Cardiovascular Medicine” medical discipline category and a discipline window 1010 for the “Radiology” medical discipline category. The window 1010 can include a list 1015 of content subcategories, which can also include an entry from the content subcategory 814. In the present example, the user selected the content subcategory 814 (FIG. 8), described as “Thorax aortogram serialogram”, from the list 805 of content subcategories under the medical discipline category “Cardiovascular Medicine”. In addition to associating the content subcategory 814 with the medical discipline category “Cardiovascular Medicine”, the medical history system associates the content subcategory 814 with the medical discipline category “Radiology”, as indicated in the related disciplines section 876 (FIG. 8). The side-by side display 1000 is generated in response to a selection of the “show all related disciplines” link 884, which is provided when a user selects a content subcategory from the list 805 (FIG. 8). The side-by-side display allows the user to compare content subcategories listed under medical discipline categories defined as being related by the medical history system as well as to compare referenced medical records under each content subcategory listed.

Using the side-by side display 1000, the user can readily identify additional referenced medical records under related medical discipline categories. Using this approach the medical history system allows users to discover independent medical records referenced by the medical history system, to which the user may not have previously had access. For example, the user can be a healthcare provider associated with a healthcare facility that maintains an independent medical records database in which medical records associated with the patient are stored. The healthcare provider can access this medical records database to view medical records associated with the patient, but may not have access to other medical records associated with the patient that are stored on another independent medical records database maintained by another healthcare facility to which the healthcare provider is not affiliated.

Using this approach, the medical history system integrates referenced medical records, which may otherwise be overlooked and therefore not discovered. This allows the user to determine the relevance of the referenced medical records as they pertain to the patient's well being and/or insurance coverage. For example, the user may determine that diagnostic tests or procedures performed on the patient, which may have been performed at another healthcare facility by another healthcare provider, may preclude the patient from receiving insurance coverage for subsequent tests or procedures. Upon discovering that certain diagnostic tests or procedures have been performed the user can retrieve the actual medical records from the disparate independent medical records database in which the medical records reside, using the medical history system, to gain insight into results of the tests and/or procedures. Likewise, the user can identify independent medical records referenced using the medical history system, which alone may not be indicative of an chronic, episodic, on-going, and/or serious medical condition, but when taken together can be indicative of a chronic, episodic, on-going, and/or serious medical condition. This ensures that the user receives real-time, complete, accurate, relevant information regarding the patient's well being.

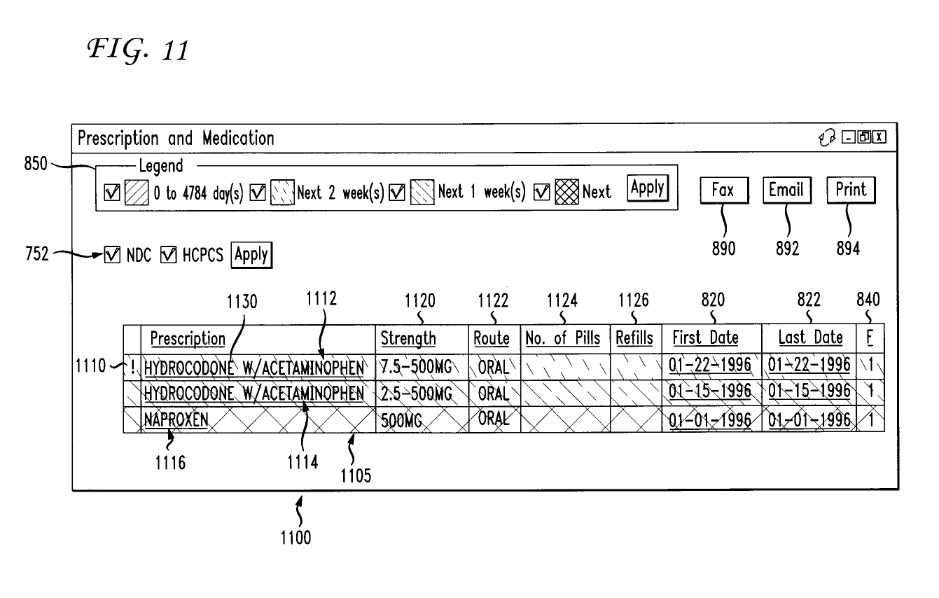

FIG. 11 illustrates an exemplary discipline window 1100 that is displayed when the user selects the “Prescription and Medication” button 740 (FIG. 7). The discipline window 1100 includes a list 1105 of prescriptions. An identifier 1110 can be associated with prescriptions to indicate the healthcare codes associated with the prescriptions have been updated. In the present example, the list 1105 of prescriptions includes a prescription entry 1112 described as “Hydrocodine w/Acetaminophen”, a prescription entry 1114 described as “Hydrocodine w/Acetaminophen”, and a prescription entry 1116 described as “Naproxen”. The list 1105 can also include a “strength” column 1120 for identifying the strength of the prescriptions, a “route” column 1122 for identifying how the prescription is to be administered, a “No. of Pills” column 1124 identifying a number of pills to be or already dispensed, a “refills” column 1126 to identify a number of refills the patient can receive, the first date 820, the last date 822, and the frequency 840.

The discipline window 1100 can include the filtering section 850 to allow the user to include and/or exclude some, all, or none of the prescriptions in the list 805 based on when medical records referenced under the prescriptions were last changed (e.g., when the medical records were last created, updated, modified, and the like). Likewise, the discipline window 1100 can include the filtering section 752 that allows a user to include and/or exclude references to medical records associated with particular sets of standardized healthcare codes. In the present example, the filtering section 752 allows the user to choose to include or exclude referenced medical records for prescriptions based on HCPCS codes and NDCs. In some embodiments, the discipline window 1100 includes export buttons, such the fax button 890, the e-mail button 892, and the print button 894, which when activated open windows to facilitate faxing, e-mailing, and printing, respectively, the patient's medical history, a portion of the patient's medical history, selected sections of the patient's medical history, and the like. Other export buttons can include a voice dictate button that when activated converts text-to-speech to dictate reference information, a send to mobile button to send reference information to a smart phone, a print e-prescribe button that prints a prescription, a send to healthcare provider to send reference information to a specific healthcare provider, and the like. The system 100 can use the reference information regarding medications and prescriptions to facilitate communications to the patient, such as by sending the patient a voice mail, e-mail, text-message, and the like, when the patient is going to need a refill on a prescription to improve medication compliance.

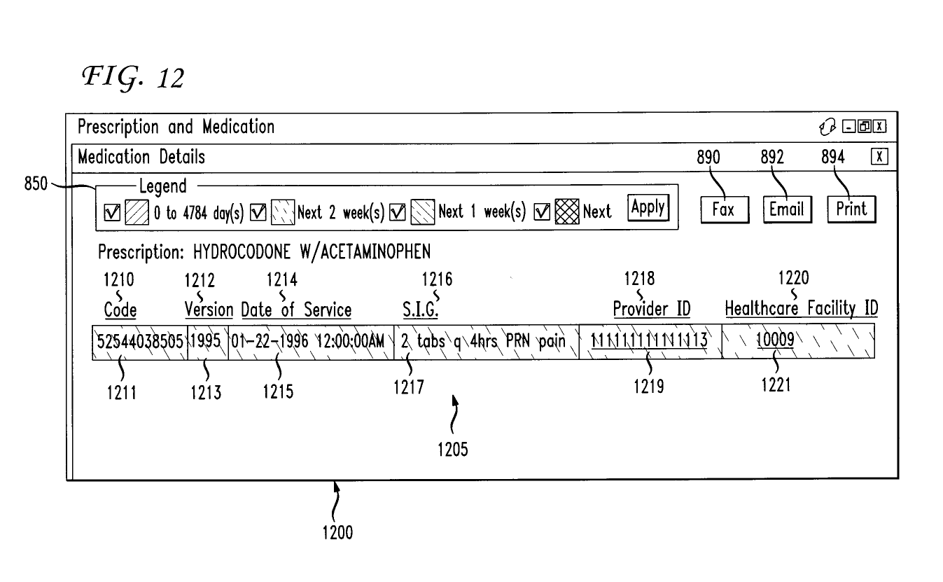

The prescriptions in the list 1105 can include selectable links that allows the user to view a medication details page associated with a prescription entry in the list 1105. For example, still referring to FIG. 11, the user can select the prescription entry 1112 by clicking a link 1130 associated with the prescription entry 1112. Upon selecting the link 1130, for example, by clicking on the link a single time or double clicking on the link 1130, the medical history system displays a medication page 1200, as shown in FIG. 12.

Referring to FIG. 12, medication page 1200 can include the filtering section 850 and export buttons, such as the fax button 890, e-mail button 892, and print button 894. Other export buttons can include a voice dictate button that when activated converts text-to-speech to dictate reference information, a send to mobile button to send reference information to a smart phone, a print e-prescribe button that prints a prescription, a send to healthcare provider to send reference information to a specific healthcare provider, and the like. The medication page 1200 includes a list 1205 of referenced medical records the medical history system has catalogued under the medical discipline category “Prescriptions and Medications” and the prescription entry 1112. The list 1205 can include a code field 1210, a version field 1212, a date of service field 1214, a “S.I.G.” field 1216 (i.e., a medication dispensing instructions field), a provider ID field 1218, a healthcare facility ID field 1220, and a retrieve record field 1222. The code field 1210 includes the standardized healthcare code 1211 associated with the medical record being referenced in the list 1205. The version field 1212 identifies a version 1213 (e.g., revision year) of the code used in the code field 910. The date of service field 1214 identifies a date 1215 when the referenced medical record was created. The S.I.G. field 1216 identifies instructions 1217 for dispensing and administering the medication. The provider ID field 1218 includes a unique identifier 1219 associated with a healthcare provider, such as a doctor, who created the referenced medical record and the healthcare facility ID field 1220 includes a unique identifier 1221 associated with a healthcare facility at which the provider provided care for the patient. The unique identifiers 1219 and 1221 can be links that when selected result in provider information and healthcare facility information, respectively. This pharmacy component allows drug-drug interaction, drug-allergy interaction, and drug-food interaction analysis to be performed in real-time, and also allows drug-disease interaction analysis to be performed in real-time based on a review of disciplines facilitated using the medical history system.

The retrieve record field 1222 can include links, for example, link 1223 to the referenced medical record in the list 1205. Upon selection of the link 1223, the medical history system retrieves the medical record for display from one of the independent medical records databases.

In one embodiment, a healthcare provider can create a medical record including medications or prescriptions and the medical record can be stored in one of the independent disparate medical records databases. The healthcare provider can inform the patient to go to the patient's designated pharmacist, without providing the patient a written prescription. When the patient arrives at the pharmacist, the pharmacist can access the medical history system to review the prescription information referenced in the medical history system. The pharmacist can also review other medications/prescription that the patient is currently taking using the medical history system. Once the pharmacist has verified the prescription information and that no conflicts exist, the pharmacist can dispense the prescription to the patient and update the underlying medical record or can insert a note into the medical history indicating that the prescription has been filled.

Referring again to FIG. 7, after the user has selected a content subcategory, the user can return to the top level medical history screen 700. If after selecting the content subcategory, the user does not view each of the related disciplines displayed in the related discipline section 876 (FIG. 8), the medical discipline categories related to the selected content subcategory are identified to alert the user that references to medical records under the identified related medical disciplines may be related to the content subcategory previously selected by the user. In some embodiments, when a user selects a medical discipline or a content subcategory of a selected medical discipline, the medical history system can automatically display the related medical disciplines, for example, in a side-by-side manner as illustrated in FIG. 10. In some embodiments, the related medical disciplines can be flashing, highlighted, the same color, and/or can include other identifiers, such as an asterisk. For example, when a user selects the content subcategory 814 (FIG. 8), described as “Thorax aortogram serialogram”, from the list 805 of content subcategories under the medical discipline category “Cardiovascular Medicine”, the medical history system can alert the user in the top level medical history screen 700 of the related discipline “Radiology” by causing the medical discipline category button 877 associated with the medical discipline “Radiology” to flash. After the user views the related medical discipline categories, the medical discipline category buttons associated with the viewed related medical discipline categories are no longer identified to alert the user of additional referenced medical records. For example, the medical discipline category buttons no longer flash.

Still referring to FIG. 7, the remarkable discipline section 710 also includes code filtering section 752 that allows a user to include and/or exclude references to medical records associated with particular sets of standardized healthcare codes. The code filtering section 752 includes selectable check boxes 754, 756, 758, and 760 corresponding to standardized ICD codes, CPT codes, HCPCS codes, and NDCs, respectively. The user can include references to medical records that use these codes by checking the check boxes and can exclude references to medical records that use these codes by unchecking the check boxes. To apply the filter, the user can select the “Apply” button 762, which excludes references to medical records that correspond only to a standardized code set that was not checked by the user.

The list 712 of medical discipline categories can be color coded to identify when a change occurs to references to medical records associated with the medical discipline categories. A legend 764 is provided for decoding the colors associated with the medical discipline categories. For example, the medical discipline category represented by the “Endocrinology” button 716 can be green, which as provided in the legend 764, indicates that there has been a change to one or more references to medical records associated with the medical discipline category “Endocrinology”. The change to the one or more references can be a modification to a medical record, discovery and referencing of a new medical record, and the like. The legend 764 includes an “Edit” button 766 to allow the user to modify the color coding to change the time frames associated with the colors, change the colors, add more time frames, remove time frames, and the like.

The top level medical history screen 700 also includes a table of contents section 768, which includes a “Master Patient Index” link 770 for navigating to a master index page, a “Patient Demographics” link 772 for navigating to a patient demographics page, a “Last Record Accessed” link 774 for navigating to a list of user access, an “Unremarkable Discipline” link 776 for navigating to a list of medical discipline categories which are not included in the remarkable disciplines section 710, an “Advanced Medical Directives” link 778 for navigating to a directive page, an “Emergency Information” link 780 for navigating to an emergency information page, a “Healthcare Providers” link 782 for navigating to a list of healthcare providers associated with the medical history of the patient, an “Insurance Information” link 784 for navigating to a page including information about the patients insurance, a “Healthcare Facilities” link 786 for navigating to a list of healthcare facilities associated with the patient's medical history, a “Legend” link 788 for navigating to page that describes various terms and/or acronyms used by the medical history system, and a disclaimer link 790 for navigating to a disclaimer regarding the user of the medical records system.

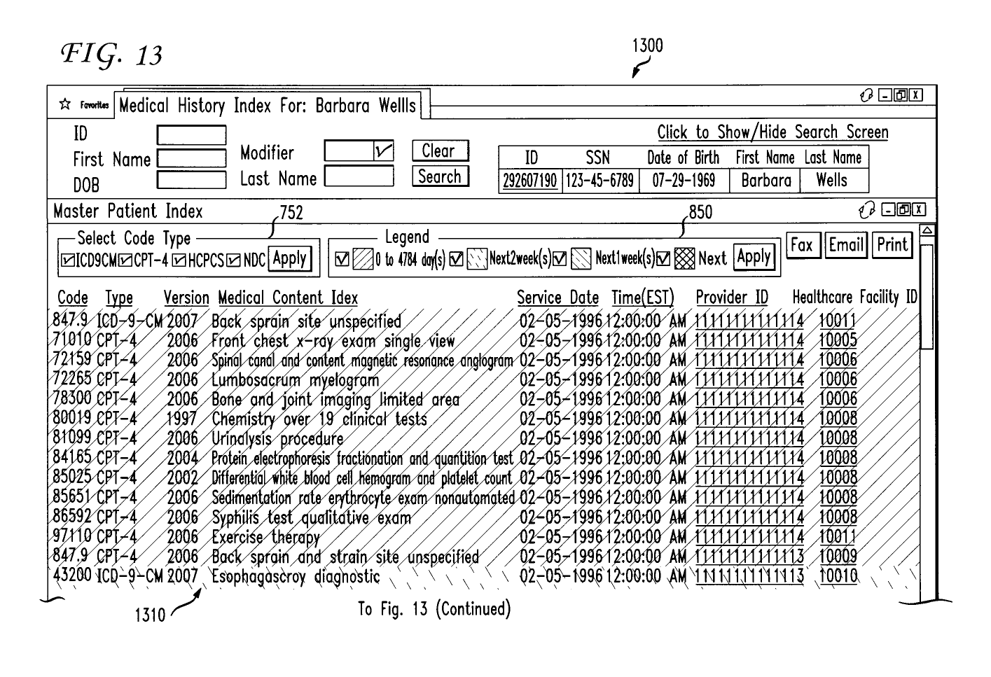

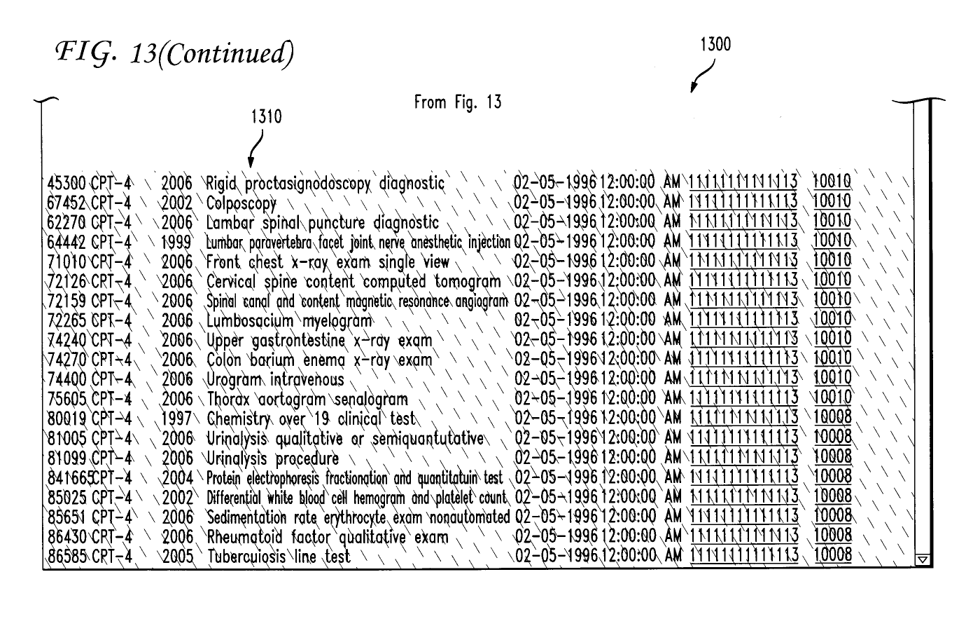

Upon selection of the “Master Patient Index” link 770, a master index page 1300 is displayed, as shown in FIG. 13. The master index page 1300 includes an aggregate list 1310 of referenced medical records included in the patients navigable medical history under the medical discipline categories. The list 1310 can be filtered using the filtering section 752 so that only referenced medical records including selected standardized healthcare codes are displayed and/or can be filtered using the filtering section 850 so that referenced medical records are displayed for medical records created, updated, or modified within selected time periods.

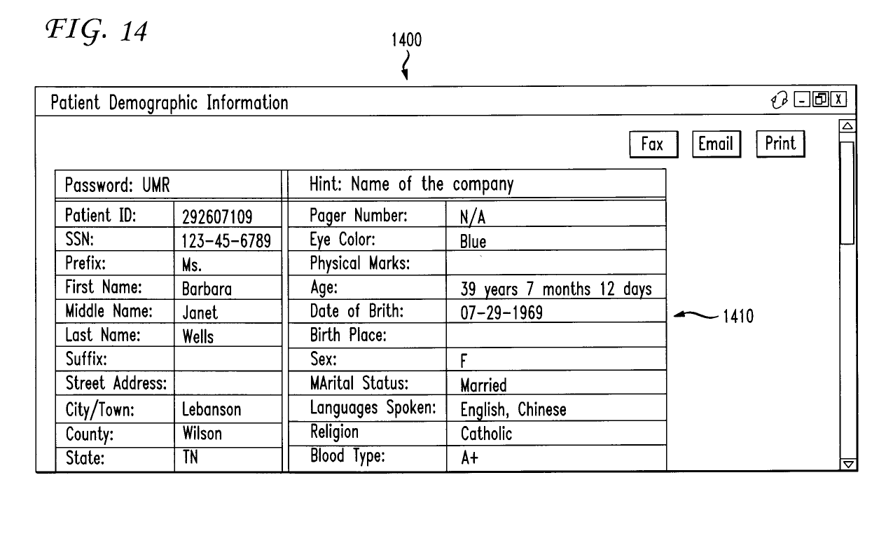

When the “Patient Demographics” link 772 is selected, a patient demographics page 1400 is displayed, as shown in FIG. 14. The patient demographics page 1400 includes patient information 1410 including a unique patient ID number, social security number, eye color, name, age, gender, date of birth, blood type, and the like. The patient information 1410 of a patient for which a navigable medical history is maintained can be entered into the medical history system during an initial set up of the medical history and can be used when discovering medical records in the disparate independent medical records databases as well as for retrieving the patients navigable medical history from the medical history system.

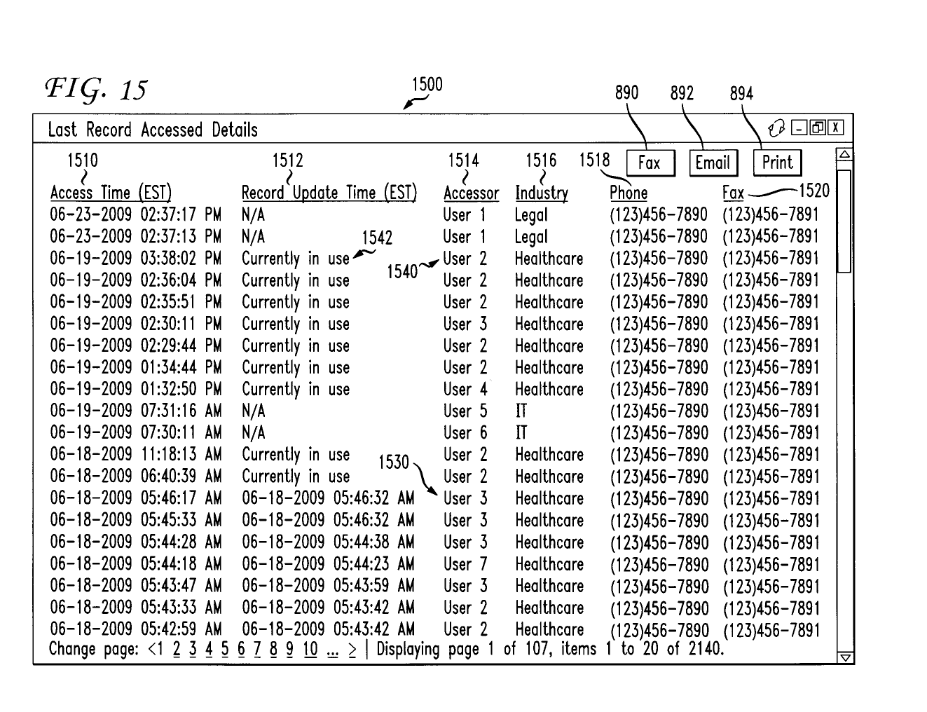

FIG. 15 illustrates an exemplary last record accessed list 1500 concerning user access that is maintained by the medical history system and that is displayed upon selection of the “Last Record Accessed” link 774 (FIG. 7). The navigation unit 160 can implement one or more software procedures to generate the list 1500 and can access one or more tables in the referenced records database to retrieve information to be included in the list 1500. For example, the navigation unit 160 can retrieve information from the patient access table to be included in the list 1500. The list 1500 includes columns for access time 1510, update time 1512, user identity 1514, industry affiliation 1516, user phone numbers 1518, and user fax numbers 1520.

The update time 1512 allows users of the medical history system to determine a status of reference information related to medical records referenced in the system. For example, a healthcare provider can create a medical record concerning a patient that has visited the healthcare provider. The system can discover the existence of the newly created medical record and can copy information from the medical record. In some instances, the medical record may be complete when the system references the medical record, and in other instances, the medical record may be incomplete when the system references the medical record. As a result, the system can indicate with an entry in the last record accessed list 1500 the healthcare provider associated with the medical record and whether the medical record has been completely updated or whether the medical record is currently in use by the healthcare provider. As an example, the user identified as “User 3” 1530 updated and completed a medical record at 5:46:32 AM on Jun. 18, 2009, while a medical records associated with the user identified as “User 2” 1540 is not completed, which is indicated by the “Currently in use” entry 1542 in the update time 1512.

The system can determine whether a medical record being referenced by the system has been updated or is currently in use using information in the medical record. For example, the medical records can include indicator information that indicates a completed update of a medical record. One example, indicator information can include a subjective, objective, assessment, and plan (SOAP) note and specifically whether the healthcare provider has entered an assessment or plan. Once the system determines that the healthcare provider has entered an assessment or plan, the system changes the status in the list 1500 from “Currently in Use” to an updated date and time.

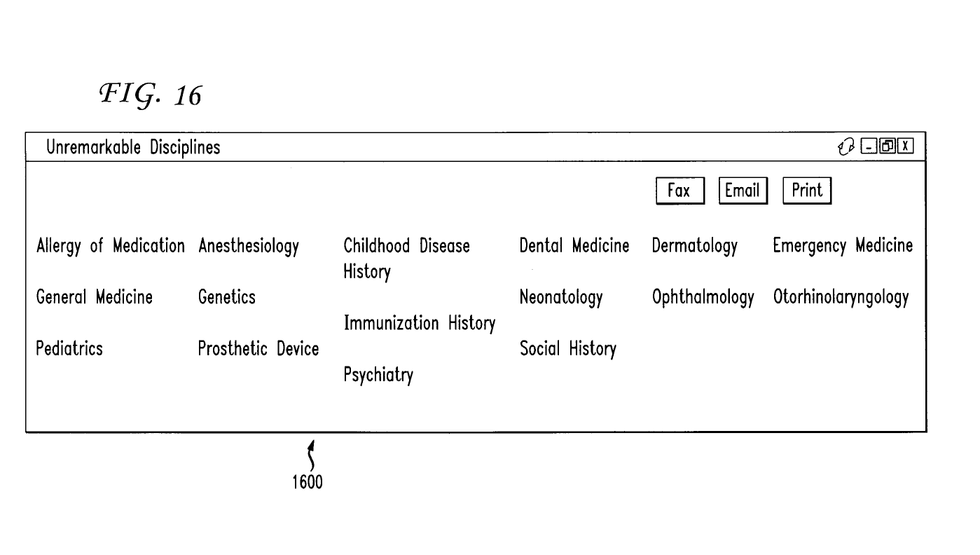

By selecting the “Unremarkable Discipline” link 776, the medical history system displays a list 1600 of unremarkable medical discipline categories, as shown in FIG. 16. The unremarkable medical discipline categories represent medical disciplines that are not included in the remarkable disciplines, for example, because no medical records are referenced under these medical disciplines categories. In the present example, the unremarkable disciplines, under which no medical records have been referenced, can include “Allergy of Medication”, “Anesthesiology”, “Childhood Disease History”, “Dental Medicine”, “Dermatology”, “Emergency Medicine”, “General Medicine”, “Genetics”, “Immunization History”, “Neonatology”, “Opthalmology”, “Otorhinolaryngology”, “Pediatrics”, “Prosthetic Device”, “Psychiatry”, and “Social History”. In some embodiments, as the referenced information becomes available for reference under the medical discipline categories in the list 1600, the medical discipline categories can be moved from the list 1600 and inserted in the list 712 (FIG. 7). The unremarkable disciplines can include additional information that may be useful when treating a patient.

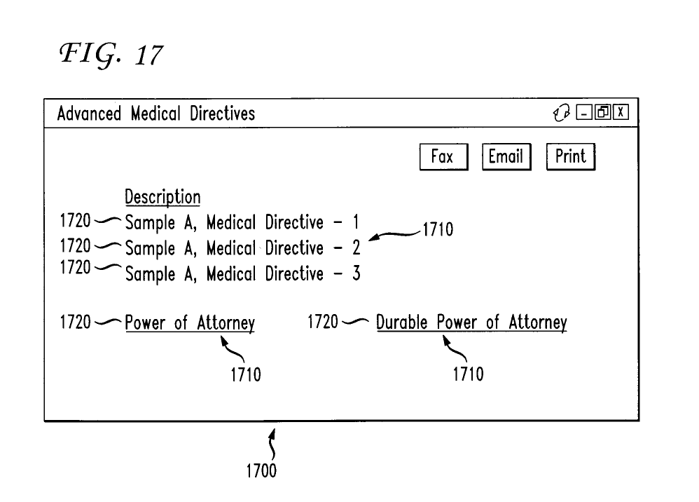

FIG. 17 shows an exemplary directives page 1700 that is displayed when the “Advanced Medical Directives” link 778 is selected. The directive page 1700 includes various medical directives 1710 that the patient may have executed, such as a living will, healthcare proxy, power of attorney, durable power of attorney, and the like. The directives page 1700 can include links 1720, which can be selected to retrieve an electronic copy of the medical directives 1710.

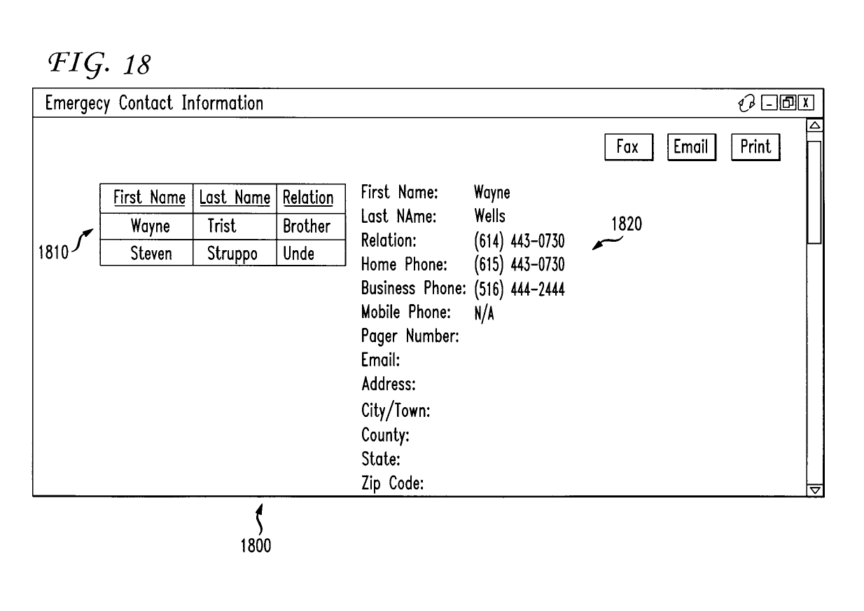

FIG. 18 shows an exemplary emergency information page 1800 is displayed when the “Emergency Information” link 780 (FIG. 7) is selected. The emergency information page 1800 includes identifies people to contact in case of an emergency. The patient can have zero or more emergency contacts identified in the emergency information page 1800. The user can select an emergency contact, such as emergency contact 1810 to display the contact information, such as contact information 1820, for the selected contact.

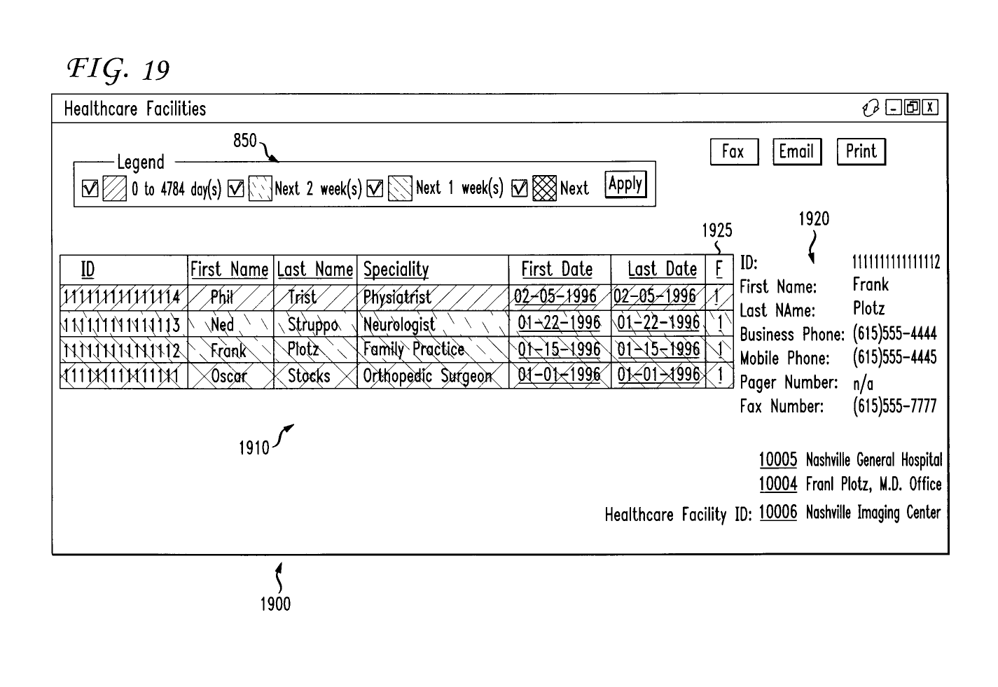

FIG. 19 shows an exemplary healthcare provider list 1900 of healthcare providers 1910 associated with the medical history of the patient, which is displayed when the “Healthcare Providers” link 782 (FIG. 7) is selected. The navigation unit 160 can implement one or more software procedures to retrieve the list 1900 of providers 1910 using information from one or more tables including the healthcare provider information table. The user can apply a filter to the list 1900 using the filtering section 850 so that healthcare providers that have created, updated, or modified medical records referenced by the navigable medical history within a selected time period are displayed. The user can view healthcare provider information 1920 by selecting one of the healthcare providers 1910 by clicking on the healthcare provider ID or the provider's name.

The list 1900 also includes the first date 820, last date 822, and the frequency 840. As discussed above the first and last date indicate a time span over which medical records referenced by the navigable medical history are created, updated, or modified. In the present example, the first date 820 and last date 822 indicate the first and last medical record created, updated, or modified by each of the healthcare providers so that the user can determine a time span over which the patient has been seeing each of the healthcare providers in the list 1900 that indicates a number of medical records created by each of the healthcare providers 1910 for the particular patient. The frequency 840 indicates the number of medical records created by each of the healthcare providers 1910 in the list 1900 so that user can determine how often the patient visited each of the healthcare providers 1910.

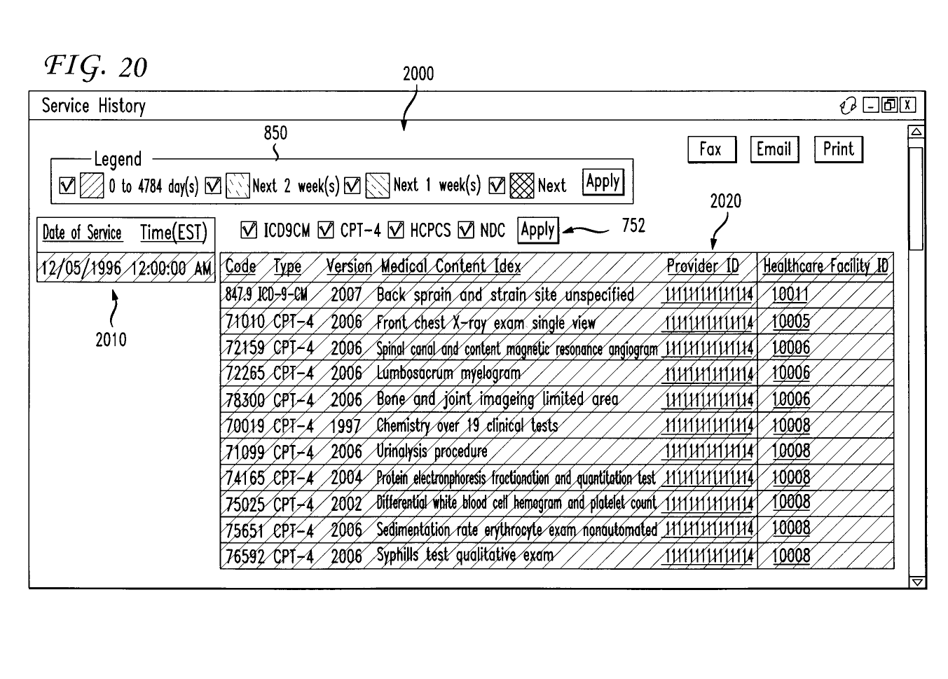

Frequency entries in the list 1900 can include links 1930. When the link 1930 is selected, the medical history system can display a service history page 2000, as shown in FIG. 20. The navigation unit 160 can implement one or more software procedures to retrieve details associated with one or more providers 1910 in the list 1900. The navigation unit 160 can use one or more tables to generate the service history page 2000 including the healthcare provider information table. The service history page 2000 includes a list 2010 of dates and times that the healthcare provider provided medical related services to the patient. A date 2012 can be selected from the list 2010 to reveal a list 2020 of referenced medical records associated with the date 2012, the provider, and the patient, which can include content subcategories that have been associated with the referenced medical records. The lists 2010 and 2020 can be filtered using the filtering sections 752 and 850 to include or exclude selected referenced medical records having including a specified type of standardized healthcare code and selected dates of service, respectively. The service history page can also include the fax button, the e-mail button, and the print button.

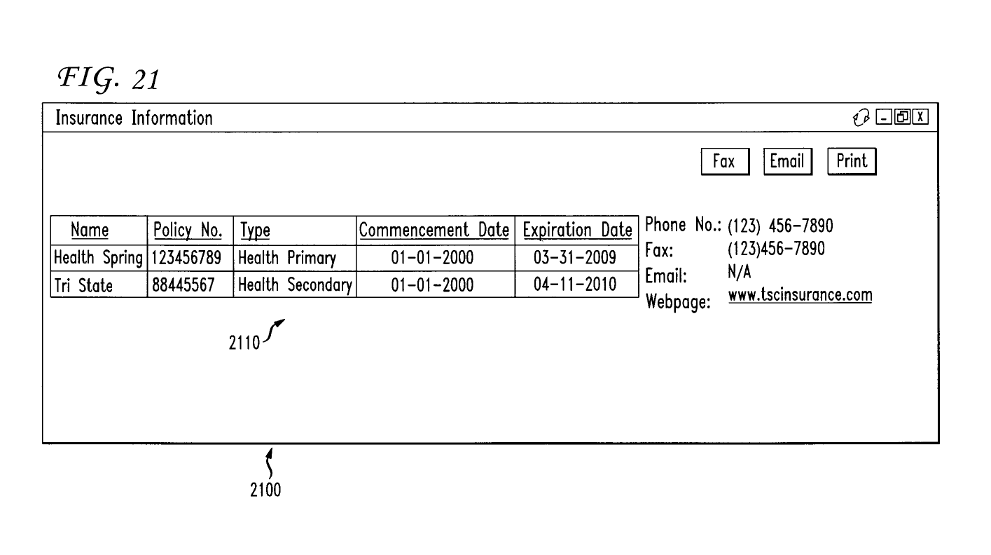

FIG. 21 illustrates an exemplary insurance page 2100 that can be displayed upon selection of the “Insurance Information” link 784 (FIG. 7). The insurance page 2100 can include a list 2110 of insurance providers associated with the patient. The entries in the list 2110 can be selectable to reveal contact information corresponding to the insurance providers. In some embodiments, the insurance page 2100 can also include additional information associated with the insurance providers in the list 2110, such as explanations of benefits, schedules of benefits, and the like.

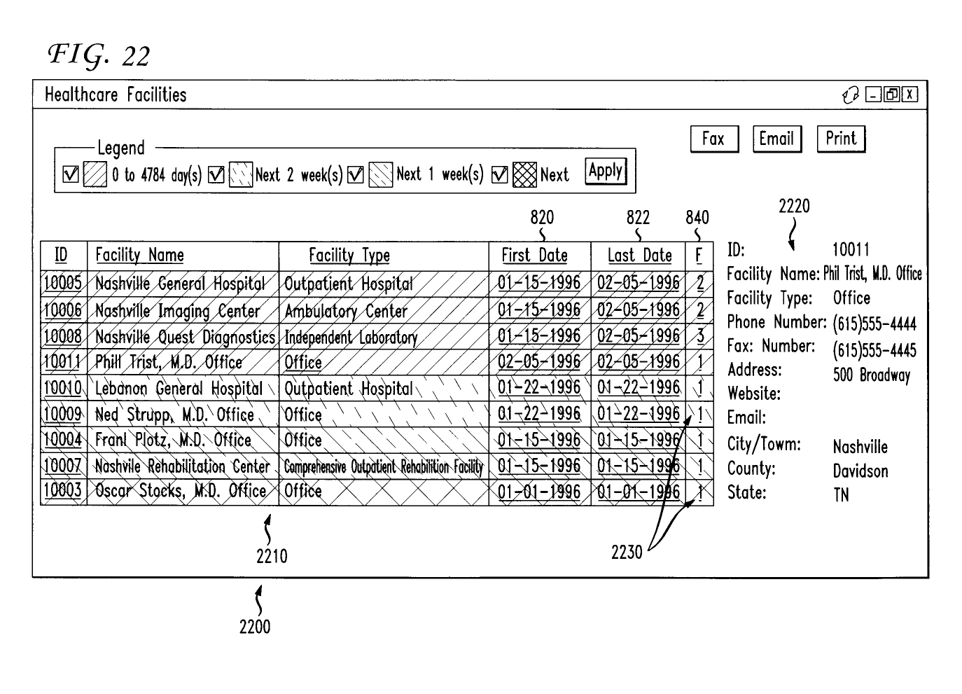

FIG. 22 shows an exemplary healthcare facilities list 2200 of healthcare facilities 2210 associated with the medical history of the patient, which is displayed when the “Healthcare Facilities” link 786 (FIG. 7) is selected. The navigation unit 160 can implement one or more software procedures to retrieve and display information relating to healthcare facilities associated with a patient that is stored in referenced records databases, for example, in one or more tables. As one example, the software procedure can retrieve information from the healthcare facility table that corresponds to the patient using the healthcare facility ID and/or patient ID. The user can view healthcare facility information 2220 by selecting one of the healthcare facilities 2210 by clicking on the healthcare facility ID or the name of the healthcare facility.

The list 2200 also includes the first date 820, last date 822, and the frequency 840. As discussed above the first and last date indicate a time span over which medical records referenced by the navigable medical history are created, updated, or modified. In the present example, the first date 820 and last date 822 indicate the first and last medical record created, updated, or modified by each of the healthcare facilities so that the user can determine a time span over which the patient has been seeing each of the healthcare facilities in the list 2200 that indicates a number of medical records created by each of the healthcare facilities 2210 for the particular patient. The frequency 840 indicates the number of medical records created by each of the healthcare facilities 2210 in the list 2200 so that user can determine how often the patient visited each of the healthcare facilities 2210.

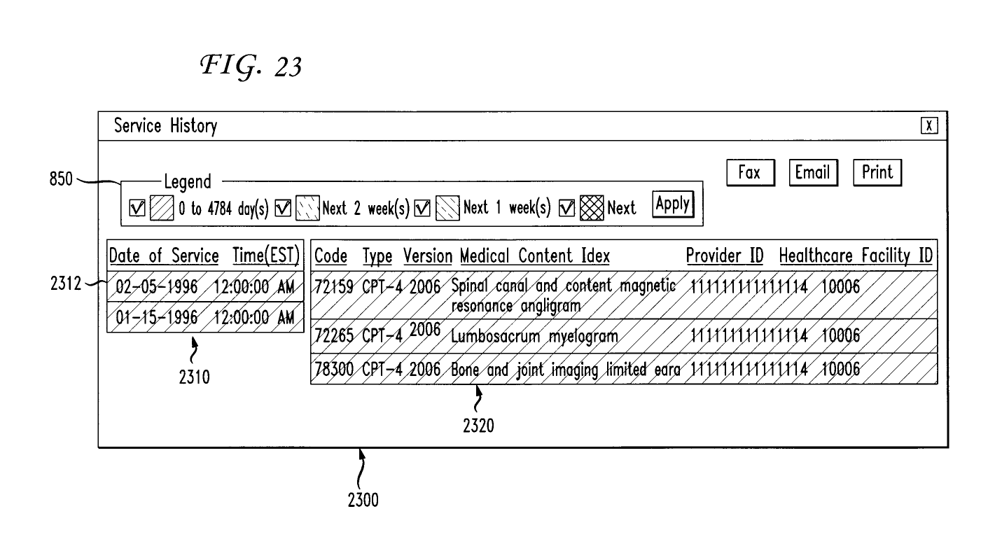

Frequency entries in the list 2200 can include links 2230. When one of the links 2230 is selected, the medical history system can display a service history page 2300, as shown in FIG. 23. The service history page 2300 includes a list 2310 of dates and times that the healthcare facilities were used to provide medical related services to the patient. A date 2312 can be selected from the list 2310 to reveal a list 2320 of referenced medical records associated with the date 2312, the provider, the healthcare facility, and the patient, which can include content subcategories that have been associated with the referenced medical records. The lists 2310 and 2320 can be filtered using the filtering section 850 to include or exclude selected referenced medical records having including a specified type of standardized healthcare code and selected dates of service, respectively. The service history page 2300 can also include the fax button 890, the e-mail button 892, and the print button 894.

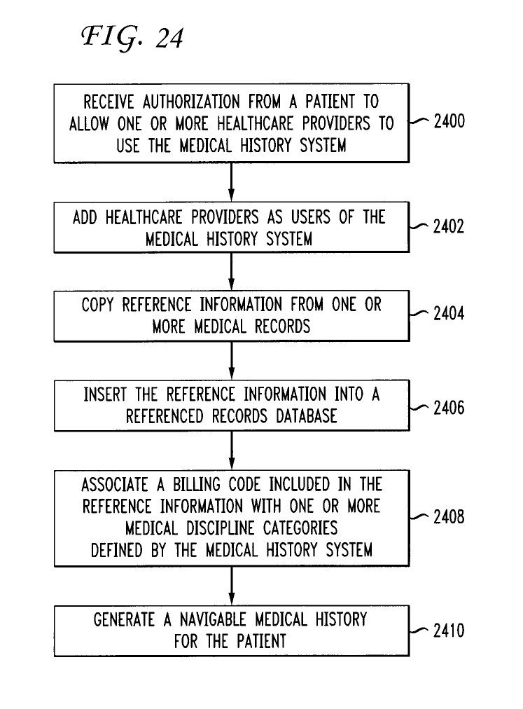

FIG. 24 is a flow chart illustrating an exemplary generation of a navigable medical history. A patient authorizes one or more healthcare providers to use the medical history system (2400). The healthcare providers are added as users to the medical history system by the administrative user (2402) and reference information is copied from one or more medical records that reside in independent disparate medical records databases (2404). The reference information is inserted into tables of the referenced records database (2406) and a healthcare code included in the reference information is associated with one or more medical discipline categories defined by the medical history system (2408). The tables are used by the medical history system to generate a navigable medical history for the patient, in which the reference information is organized under medical discipline categories and content subcategories (2410).

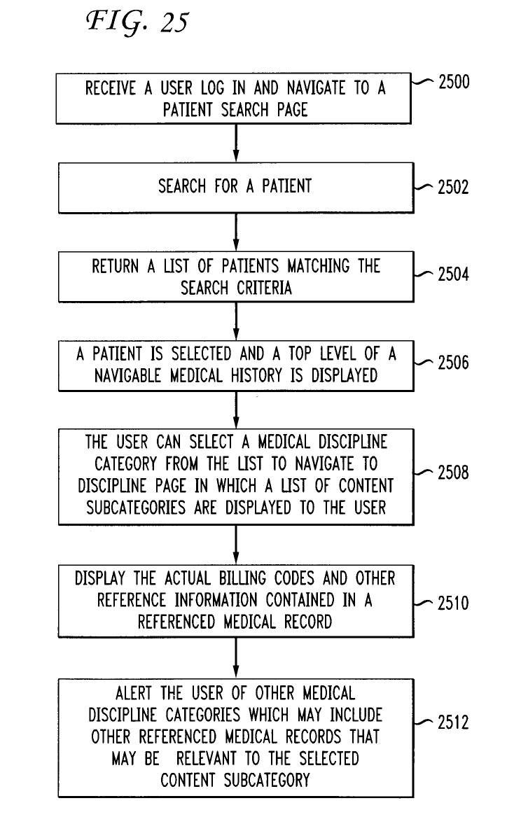

FIG. 25 is a flowchart illustrating an exemplary navigation of a patient's medical history. A user can log in to the medical history system and navigate to a patient search page (2500). The user can enter information corresponding to a patient for which a navigable medical history is desired and a search can be performed (2502). The search returns a list of patients that are associated with the user who match the user's search criteria (2504). The user selects a patient from the list and a top level of a navigable medical history associated with the patient is displayed to the user (2506). The top level includes a table of contents and a list of selectable medical discipline categories.

The user can select a medical discipline category from the list to navigate to discipline page in which a list of content subcategories are displayed to the user (2508). Entries in the list of content subcategories includes a description of the contents of medical records referenced under the content subcategories, a first and last date of service, and a number of medical records that are referenced under each of the content subcategories. Upon selection of a content subcategory, the user can view the actual healthcare codes and other reference information contained in a referenced medical record (2510) and the user is alerted to medical discipline categories which may include other referenced medical records that may be relevant to the selected content subcategory (2512).

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method for providing a medical history of a patient using a computing system having one or more computers, the computing system being configured to implement a medical history system, the method comprising:
storing reference information related to medical records for a patient in a referenced records database based on a healthcare code in the medical records, the reference information being inserted into the referenced records database by the medical history system; and
generating, with the medical history system, a navigable medical history associated with the patient based on the reference information, the navigable medical history organized by one or more medical discipline categories.

2. The method of claim 1, wherein storing reference information comprises associating the healthcare code with one or more medical discipline categories defined by the medical history system.

3. The method of claim 2, further comprising displaying a list including a content subcategory in response to a selection of a first one of the medical discipline categories, the content subcategory including a description of content contained in one or more of the medical records.

4. The method of claim 3, further comprising displaying reference information associated with the one or more of the medical records in response to a selection of the content subcategory.

5. The method of claim 4, further comprising:
inserting a link into the reference information; and
retrieving a corresponding one of the medical records from a medical records database in which the corresponding one of the medical records resides in response to a selection of the link.

6. The method of claim 5, wherein the corresponding one of medical records is stored and maintained independently from the medical history system.

7. The method of claim 3, wherein the list includes an entry identifying a number of medical records that correspond to the content subcategory.

8. The method of claim 3, wherein the list includes an entry identifying a first date on which the patient was serviced and a last date on which the patient was serviced corresponding to the medical records referenced by the content subcategory.

9. The method of claim 3, further comprising:
generating a predefined relationship between the content subcategory and a second one of the medical discipline categories;
determining when a user selects the content subcategory associated with the first one of the medical discipline categories; and
alerting the user of the relationship between the content subcategory and the second one of the medical discipline categories in response to a selection of the content subcategory.

10. The method of claim 1, wherein the navigable medical history includes a last record accessed list identifying a status of at least one of the medical records for which the reference information is stored.

11. The method of claim 1, further comprising:
determining identities of healthcare providers who have treated the patient using the reference information; and
generating a list of the healthcare providers who have treated the patient, the list including a total number of medical records each of the healthcare providers have generated for the patient and including a time span over which each of the healthcare providers have treated the patient.

12. The method of claim 1, further comprising:
receiving search terms for identifying the patient;
displaying a list of potential patients matching the search terms; and
retrieving the navigable medical history in response to a selection of the patient from the list of potential patients.

13. The method of claim 1, further comprising:
retrieving medical records associated with the patient from independent disparate medical records databases; and
copying the reference information from the medical records that are retrieved.

14. A computer readable medium storing instructions executable by a computing system including at least one computing device, wherein execution of the instructions implements a method for providing a medical history of a patient comprising:
storing reference information related to medical records for a patient in a referenced records database based on a healthcare code in the medical records, the reference information being inserted into the referenced records database by the medical history system; and
generating, with the medical history system, a navigable medical history associated with the patient based on the reference information, the navigable medical history organized by the medical discipline categories.

15. The medium of claim 14, wherein storing reference information comprises associating the healthcare code with one or more medical discipline categories defined by the medical history system.

16. The medium of claim 15, further comprising displaying a list including a content subcategory in response to a selection of a first one of the medical discipline categories, the content subcategory including a description of content contained in one or more of the medical records.

17. The medium of claim 16, wherein the list includes an entry identifying a number of medical records that correspond to the content subcategory.

18. The medium of claim 16, wherein the list includes an entry identifying a first date on which the patient was serviced and a last date on which the patient was serviced corresponding to the medical records referenced by the content subcategory.

19. The medium of claim 16, further comprising:
generating a predefined relationship between the content subcategory and a second one of the medical discipline categories;
determining when a user selects the content subcategory associated with the first one of the medical discipline categories; and
alerting the user of the relationship between the content subcategory and the second one of the medical discipline categories in response to a selection the content subcategory.

20. A system for providing a medical history of a patient comprising:
a computer system having one or more computing devices, the computing system including a medical history system configured to:
store reference information related to medical records for a patient in a referenced records database based on an association between a healthcare code in the medical records, the reference information being inserted into the referenced records database; and
generate a navigable medical history associated with the patient based on the reference information, the navigable medical history organized by the medical discipline categories.

21. The system of claim 20, wherein the computing system is configured to associate the healthcare code with one or more medical discipline categories defined by the medical history system.

22. The system of claim 21, wherein a list including a content subcategory is displayed in response to a selection of a first one of the medical discipline categories, the content subcategory including a description of content contained in one or more of the medical records.

23. The system of claim 22, wherein the computing system is configured to insert a link into the reference information and retrieve a corresponding one of the medical records from a medical records database in which the corresponding one of the medical records resides in response to a selection of the link.

24. The system of claim 22, wherein the list includes an entry identifying at least one of a number of medical records that correspond to the content subcategory, a first date on which the patient was serviced, and a last date on which the patient was serviced.

25. The system of claim 22, wherein the computing system is configured to generate a predefined relationship between the content subcategory and a second one of the medical discipline categories, determine when a user selects the content subcategory, and alert the user of the relationship between the content subcategory and the second one of the medical discipline categories in response to selection of the content subcategory.

26. The system of claim 20, wherein the navigable medical history includes a last record accessed list identifying a status of at least one of the medical records for which the reference information is stored.
